(19) United States
(12) Patent Application Publication
(10) Pub. No.: US 2025/0334780 A1
(43) Pub. Date: Oct. 30, 2025

(54) IMAGING OPTICAL SYSTEM, AND IMAGE CAPTURE DEVICE AND CAMERA SYSTEM INCLUDING THE SAME

(71) Applicant: Panasonic Intellectual Property Management Co., Ltd., Osaka (JP)

(72) Inventors: Takahiro KITADA, Osaka (JP); Shoichi Ikeshita, Osaka (JP); Itaru Watanabe, Osaka (JP)

(21) Appl. No.: 19/187,014

(22) Filed: Apr. 23, 2025

(30) Foreign Application Priority Data
Apr. 24, 2024 (JP) 2024-070789
Apr. 22, 2025 (JP) 2025-070181

(51) Int. Cl. G02B 13/00; G02B 7/02; G02B 7/14; G02B 15/14; G03B 17/14

(52) U.S. Cl. CPC G02B 13/009; G02B 7/021; G02B 7/025; G02B 7/14; G02B 13/0045; G02B 13/006; G02B 15/143503; G03B 17/14

(57) ABSTRACT

An imaging optical system consists of: a first lens group having negative power; a second lens group having positive power; and a third lens group having power. The first, second, and third lens groups are arranged in this order such that the first lens group is located closest to an object and that the third lens group is located closest to an image plane. The first, second, and third lens groups move along an optical axis of the imaging optical system such that an interval between adjacent ones of the first, second, and third lens groups changes while the imaging optical system is zooming from a wide-angle end toward a telephoto end. The imaging optical system satisfies the following inequality: 1.85<L1nd, where L1nd is a refractive index of a negative lens located closest to the object.

### CROSS-REFERENCE TO RELATED APPLICATIONS

The present application is based upon, and claims the benefit of priority to, each of Japanese Patent Application No. 2024-070789, filed on Apr. 24, 2024, and Japanese Patent Application No. 2025-070181, filed on Apr. 22, 2025, the entire contents of which are hereby incorporated by reference.

### TECHNICAL FIELD

The present disclosure relates to an imaging optical system having the ability to compensate for various types of aberrations sufficiently over the entire zoom range and also relates to an image capture device and camera system including such an imaging optical system.

### BACKGROUND ART

JP 2016-062053 A discloses a zoom lens including a first lens group having negative refractive power, a second lens group having positive refractive power, and a third lens group having negative refractive power. The first, second, and third lens groups are arranged in this order such that the first lens group is located closer to an object than the second or third lens group is and that the third lens group is located closer to an image plane than the first or second lens group is. In the zoom lens, these three lens groups move such that the interval between two adjacent lens groups changes while the zoom lens is zooming. The zoom lens is characterized by the ratio of β2t to β2w and the ratio of β3t to β3w, where β2w is a lateral magnification of the second lens group at a wide-angle end, β2t is a lateral magnification of the second lens group at a telephoto end, β3w is a lateral magnification of the third lens group at the wide-angle end, and β3t is a lateral magnification of the third lens group at the telephoto end.

### SUMMARY

The present disclosure provides an imaging optical system having the ability to compensate for various types of aberrations sufficiently over the entire zoom range and an image capture device and interchangeable lens unit including such an imaging optical system.

An imaging optical system according to an aspect of the present disclosure consists of: a first lens group having negative power; a second lens group having positive power; and a third lens group having power. The first, second, and third lens groups are arranged in this order such that the first lens group is located closer to an object than the second or third lens group is, and that the third lens group is located closer to an image plane than the first or second lens group is. The first lens group, the second lens group, and the third lens group move along an optical axis of the imaging optical system such that an interval between adjacent ones of the first, second, and third lens groups changes while the imaging optical system is zooming from a wide-angle end toward a telephoto end. The imaging optical system satisfies the following inequality (1):

$$1.85 < L 1 nd \qquad ( 1 )$$

where L1nd is a refractive index of a negative lens located closest to the object.

A camera system according to another aspect of the present disclosure includes: an interchangeable lens unit including the imaging optical system described above; and a camera body including: an image sensor configured to receive an optical image of an object formed by the imaging optical system and transform the optical image into an electrical image signal; and a camera mount. The camera body is configured to be connected removably to the interchangeable lens unit via the camera mount. The interchangeable lens unit is configured to form the optical image of the object on the image sensor.

An image capture device according to still another aspect of the present disclosure is configured to transform an optical image of an object into an electrical image signal and display and/or store the electrical image signal thus transformed. The image capture device includes: the imaging optical system configured to form the optical image of the object; and an image sensor configured to transform the optical image formed by the imaging optical system into the electrical image signal.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1A illustrates lens arrangements showing an infinity in-focus state of an imaging optical system according to a first embodiment (corresponding to a first example of numerical values);

FIG. 1B illustrates longitudinal aberration diagrams showing the infinity in-focus state of the imaging optical system in the first example of numerical values;

FIG. 2A illustrates lens arrangements showing an infinity in-focus state of an imaging optical system according to a second embodiment (corresponding to a second example of numerical values);

FIG. 2B illustrates longitudinal aberration diagrams showing the infinity in-focus state of the imaging optical system in the second example of numerical values;

FIG. 3A illustrates lens arrangements showing an infinity in-focus state of an imaging optical system according to a third embodiment (corresponding to a third example of numerical values);

FIG. 3B illustrates longitudinal aberration diagrams showing the infinity in-focus state of the imaging optical system in the third example of numerical values;

FIG. 4A illustrates lens arrangements showing an infinity in-focus state of an imaging optical system according to a fourth embodiment (corresponding to a fourth example of numerical values);

FIG. 4B illustrates longitudinal aberration diagrams showing the infinity in-focus state of the imaging optical system in the fourth example of numerical values;

FIG. 5A illustrates lens arrangements showing an infinity in-focus state of an imaging optical system according to a fifth embodiment (corresponding to a fifth example of numerical values);

FIG. 5B illustrates longitudinal aberration diagrams showing the infinity in-focus state of the imaging optical system in the fifth example of numerical values;

FIG. 6 illustrates a schematic configuration for an image capture device according to the first embodiment; and

FIG. 7 illustrates a schematic configuration for a camera system according to the first embodiment.

### DETAILED DESCRIPTION

Embodiments of the present disclosure will now be described in detail with reference to the accompanying drawings as needed. Note that unnecessarily detailed description will be omitted. For example, detailed description of already well-known matters and redundant description of substantially the same configuration will be omitted. This is done to avoid making the following description overly redundant and thereby help one of ordinary skill in the art understand the present disclosure easily.

In addition, note that the accompanying drawings and the following description are provided to help one of ordinary skill in the art understand the present disclosure fully and should not be construed as limiting the scope of the present disclosure, which is defined by the appended claims.

### First to Fifth Embodiments

Imaging optical systems according to first to fifth embodiments will now be described on an individual basis with reference to the accompanying drawings.

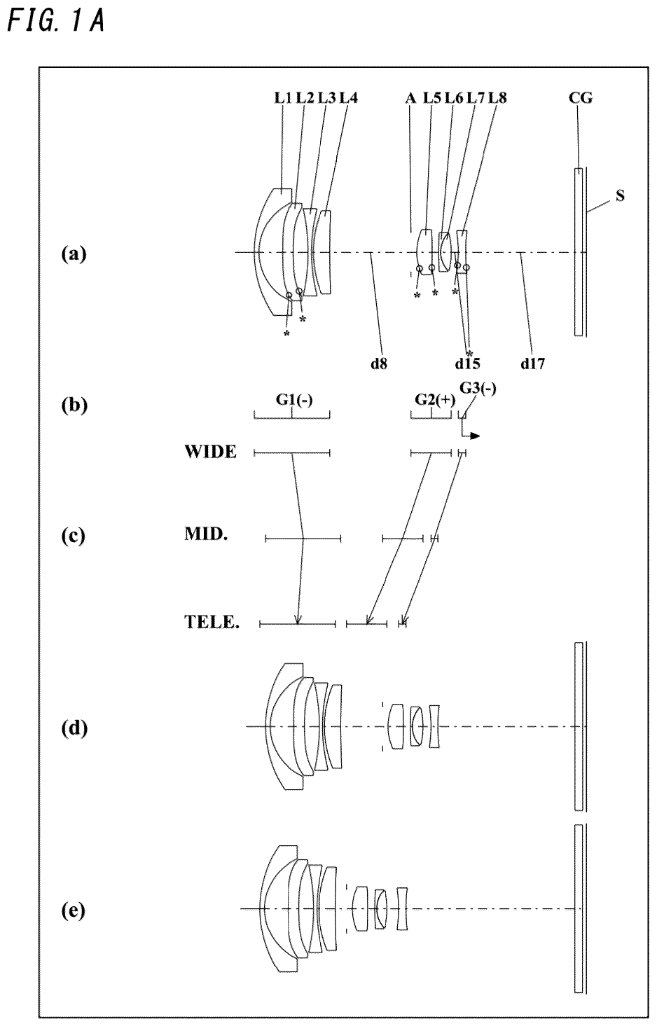

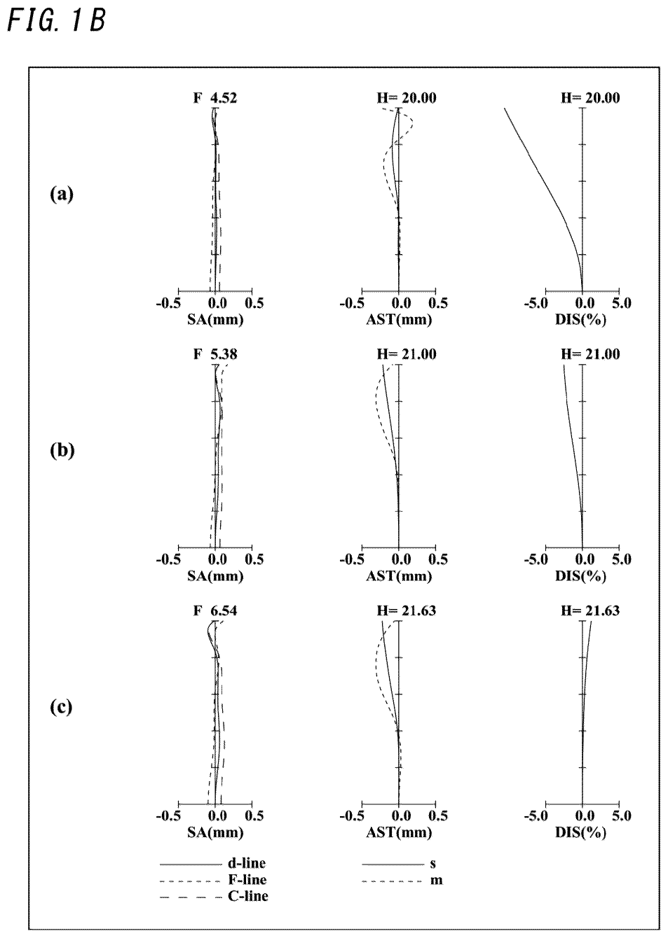

FIGS. 1A, 2A, 3A, 4A, and 5A illustrate lens arrangements of imaging optical systems according to the first to fifth embodiments, respectively. In each of FIGS. 1A, 2A, 3A, 4A, and 5A, the imaging optical system is in an infinity in-focus state.

In FIGS. 1A, 2A, 3A, 4A, and 5A, portion (a) illustrates a lens arrangement at a wide-angle end (which is a state with the shortest focal length fw); portion (d) illustrates a lens arrangement at a middle position (which is a state with a middle focal length fM=√(fw*fT)); and portion (e) illustrates a lens arrangement at a telephoto end (which is a state with the longest focal length fT). Note that portions (a), (d), and (e) of FIGS. 1A, 2A, 3A, 4A, and 5A have the same aspect ratio.

Furthermore, in portion (a) of FIGS. 1A, 2A, 3A, 4A, and 5A, the asterisk (*) attached to a surface of a particular lens indicates that the surface is an aspheric surface. Note that in the lenses shown in portion (a) of FIGS. 1A, 2A, 3A, 4A, and 5A, an object-side surface or an image-side surface having no asterisks is a spherical surface.

Also, in FIGS. 1A, 2A, 3A, 4A, and 5A, the polygon arrows shown in portion (c) thereof each connect together the respective positions of the lens groups at the wide-angle end (WIDE), middle position (MID), and telephoto end (TELE) from top to bottom. Note that these polygon arrows just connect the wide-angle end to the middle position and the middle position to the telephoto end with the lines, and do not indicate the actual movement of the lens groups.

Furthermore, in portion (b) of FIGS. 1A, 2A, 3A, 4A, and 5A, the respective lens groups are designated by the reference signs G1-G3 corresponding to their respective positions shown in portion (a).

Furthermore, the signs (+) and (−) added to the reference signs G1-G3 of the respective lens groups in portion (b) of FIGS. 1A, 2A, 3A, 4A, and 5A indicate the powers of the respective lens groups G1-G3. That is to say, the positive sign (+) indicates positive power, and the negative sign (−) indicates negative power.

Also, the arrows added to the lens groups in portion (b) of FIGS. 1A, 2A, 3A, 4A, and 5A each indicate focusing to make a transition from the infinity in-focus state toward the close-object in-focus state. Note that in FIGS. 1A, 2A, 3A, 4A, and 5A, the reference signs of respective lens groups are shown under the respective lens groups in portion (a) thereof, and therefore, an arrow indicating focusing is shown under the sign of each lens group for convenience's sake. In each zooming state, the directions of movement of the respective lens groups during focusing will be described more specifically later with respect to each of the first through fifth embodiments.

Furthermore, in portions (a), (d), and (e) of FIGS. 1A, 2A, 3A, 4A, and 5A, the straight line drawn at the right end indicates the position of the image plane S (i.e., a surface, facing the object, of the image sensor). Therefore, the left end of the drawings corresponds to the object side. Furthermore, a parallel plate such as a low-pass filter or cover glass is disposed between the lens group on the last stage, facing the image plane S, of the imaging optical system and the image plane S.

### First Embodiment

FIG. 1A illustrates an imaging optical system according to a first embodiment.

The imaging optical system is made up of: a first lens group G1 having negative power; a second lens group G2 having positive power; and a third lens group G3 having negative power. The first, second, and third lens groups G1, G2, G3 are arranged in this order such that the first lens group G1 is located closer to an object than the second or third lens group G2, G3 is and that the third lens group G3 is located closer to an image plane than the first or second lens group G1, G2 is.

The imaging optical system forms an image at a point on the image plane S.

The first lens group G1 is made up of: a first lens L1 having negative power; a second lens L2 having negative power; a third lens L3 having negative power; and a fourth lens L4 having positive power. The first lens L1, the second lens L2, the third lens L3, and the fourth lens L4 are arranged in this order such that the first lens L1 is located closer to the object than any other member of this first lens group G1 is and that the fourth lens L4 is located closer to the image plane than any other member of this first lens group G1 is.

The second lens group G2 is made up of: an aperture stop A; a fifth lens L5 having positive power; a sixth lens L6 having negative power; and a seventh lens L7 having positive power. The aperture stop A and the fifth, sixth, and seventh lenses L5, L6, L7 are arranged in this order such that the aperture stop A is located closer to the object than any other member of this second lens group G2 is and that the seventh lens L7 is located closer to the image plane than any other member of this second lens group G2 is. The sixth lens L6 and the seventh lens L7 are bonded together with an adhesive, for example, to form a bonded lens.

The third lens group G3 consists of an eighth lens L8 having negative power.

The respective lenses will be described.

First, the respective lenses that form the first lens group G1 will be described. The first lens L1 is a meniscus lens having a convex surface facing the object. The second lens L2 is a meniscus lens having a convex surface facing the object. Each of the two surfaces of the second lens L2 has an aspheric shape. The third lens L3 is a biconcave lens. The fourth lens L4 is a meniscus lens having a convex surface facing the object.

Next, the respective lenses belonging to the second lens group G2 will be described. The fifth lens L5 is a biconvex lens. Each of the two surfaces of the fifth lens L5 has an aspheric shape. The sixth lens L6 is a meniscus lens having a convex surface facing the object. The seventh lens L7 is a biconvex lens.

Next, the lens that forms the third lens group G3 will be described. The eighth lens L8 is a biconcave lens. Each of the two surfaces of the eighth lens L8 has an aspheric shape.

While the imaging optical system according to the first embodiment is zooming from the wide-angle end toward the telephoto end during a shooting session, the first lens group G1, the second lens group G2, and the third lens group G3 all move with respect to the image plane S. In the meantime, as the imaging optical system is zooming from the wide-angle end toward the telephoto end during the shooting session, the first, second and third lens groups G1, G2, G3 move along the optical axis such that the interval between the first lens group G1 and the second lens group G2 decreases, the interval between the second lens group G2 and the third lens group G3 increases, and the interval between the third lens group G3 and the image plane S increases.

While the imaging optical system according to the first embodiment is focusing to make a transition from the infinity in-focus state to the close-object in-focus state, the third lens group G3 moves along the optical axis toward the image plane.

### Second Embodiment

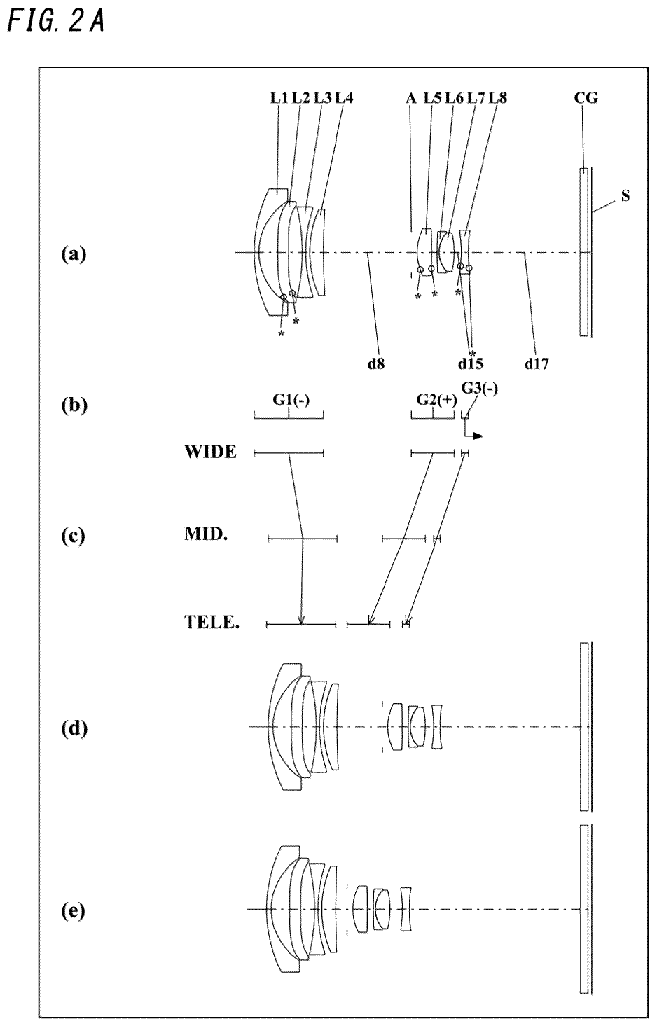

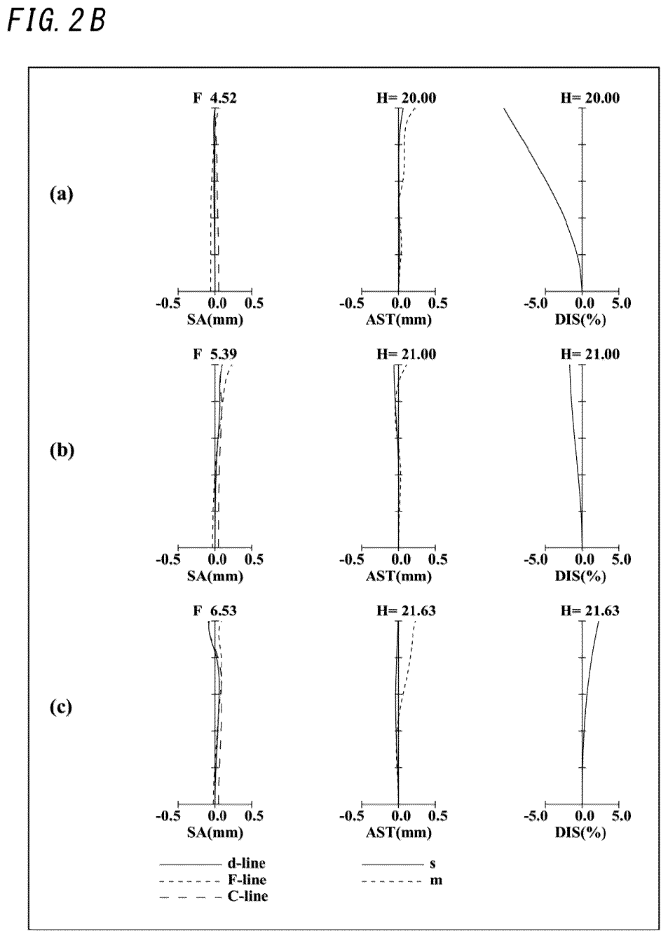

FIG. 2A illustrates an imaging optical system according to a second embodiment.

The imaging optical system is made up of: a first lens group G1 having negative power; a second lens group G2 having positive power; and a third lens group G3 having negative power. The first, second, and third lens groups G1, G2, G3 are arranged in this order such that the first lens group G1 is located closer to an object than the second or third lens group G2, G3 is and that the third lens group G3 is located closer to an image plane than the first or second lens group G1, G2 is.

The imaging optical system forms an image at a point on the image plane S.

The first lens group G1 is made up of: a first lens L1 having negative power; a second lens L2 having positive power; a third lens L3 having negative power; and a fourth lens L4 having positive power. The first lens L1, the second lens L2, the third lens L3, and the fourth lens L4 are arranged in this order such that the first lens L1 is located closer to the object than any other member of this first lens group G1 is and that the fourth lens L4 is located closer to the image plane than any other member of this first lens group G1 is.

The second lens group G2 is made up of: an aperture stop A; a fifth lens L5 having positive power; a sixth lens L6 having negative power; and a seventh lens L7 having positive power. The aperture stop A and the fifth, sixth, and seventh lenses L5, L6, L7 are arranged in this order such that the aperture stop A is located closer to the object than any other member of this second lens group G2 is and that the seventh lens L7 is located closer to the image plane than any other member of this second lens group G2 is. The sixth lens L6 and the seventh lens L7 are bonded together with an adhesive, for example, to form a bonded lens.

The third lens group G3 consists of an eighth lens L8 having negative power.

The respective lenses will be described.

First, the respective lenses that form the first lens group G1 will be described. The first lens L1 is a meniscus lens having a convex surface facing the object. The second lens L2 is a meniscus lens having a convex surface facing the object. Each of the two surfaces of the second lens L2 has an aspheric shape. The third lens L3 is a biconcave lens. The fourth lens L4 is a meniscus lens having a convex surface facing the object.

Next, the respective lenses belonging to the second lens group G2 will be described. The fifth lens L5 is a biconvex lens. Each of the two surfaces of the fifth lens L5 has an aspheric shape. The sixth lens L6 is a meniscus lens having a convex surface facing the object. The seventh lens L7 is a biconvex lens.

Next, the lens that forms the third lens group G3 will be described. The eighth lens L8 is a biconcave lens. Each of the two surfaces of the eighth lens L8 has an aspheric shape.

While the imaging optical system according to the second embodiment is zooming from the wide-angle end toward the telephoto end during a shooting session, the first lens group G1, the second lens group G2, and the third lens group G3 all move with respect to the image plane S. In the meantime, as the imaging optical system is zooming from the wide-angle end toward the telephoto end during the shooting session, the first, second and third lens groups G1, G2, G3 move along the optical axis such that the interval between the first lens group G1 and the second lens group G2 decreases, the interval between the second lens group G2 and the third lens group G3 increases, and the interval between the third lens group G3 and the image plane S increases.

While the imaging optical system according to the second embodiment is focusing to make a transition from the infinity in-focus state to the close-object in-focus state, the third lens group G3 moves along the optical axis toward the image plane.

### Third Embodiment

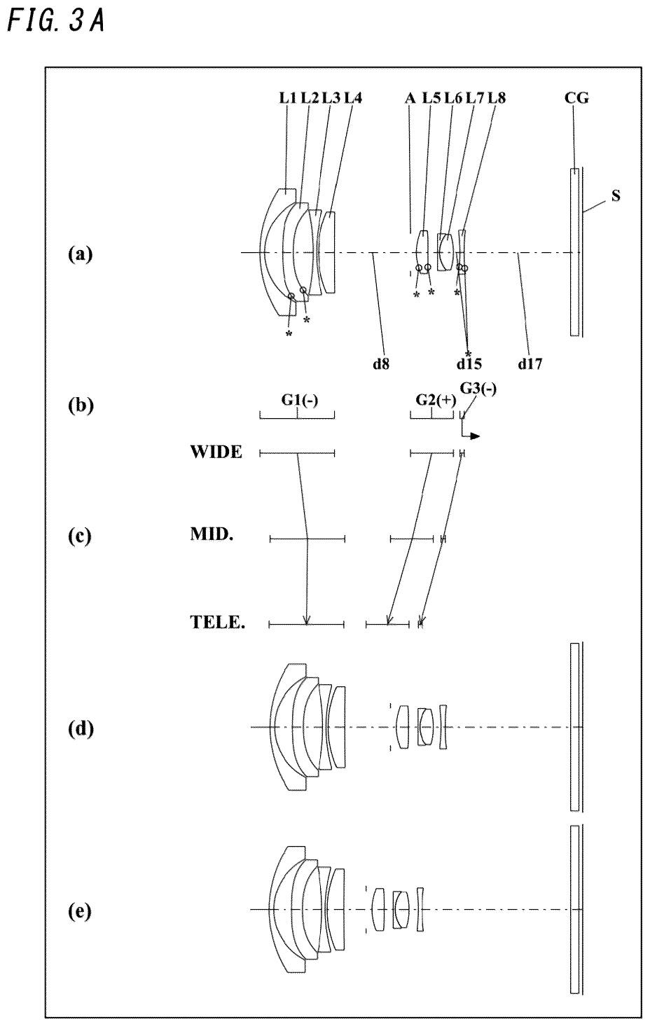

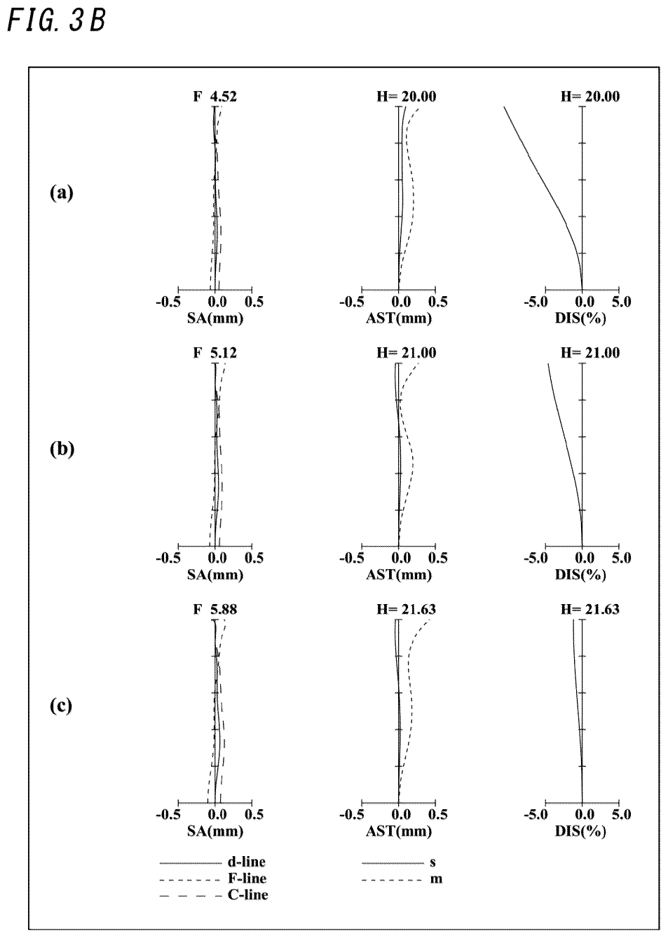

FIG. 3A illustrates an imaging optical system according to a third embodiment.

The imaging optical system is made up of: a first lens group G1 having negative power; a second lens group G2 having positive power; and a third lens group G3 having negative power. The first, second, and third lens groups G1, G2, G3 are arranged in this order such that the first lens group G1 is located closer to an object than the second or third lens group G2, G3 is and that the third lens group G3 is located closer to an image plane than the first or second lens group G1, G2 is.

The imaging optical system forms an image at a point on the image plane S.

The first lens group G1 is made up of: a first lens L1 having negative power; a second lens L2 having negative power; a third lens L3 having negative power; and a fourth lens L4 having positive power. The first lens L1, the second lens L2, the third lens L3, and the fourth lens L4 are arranged in this order such that the first lens L1 is located closer to the object than any other member of this first lens group G1 is and that the fourth lens L4 is located closer to the image plane than any other member of this first lens group G1 is.

The second lens group G2 is made up of: an aperture stop A; a fifth lens L5 having positive power; a sixth lens L6 having negative power; and a seventh lens L7 having positive power. The aperture stop A and the fifth, sixth, and seventh lenses L5, L6, L7 are arranged in this order such that the aperture stop A is located closer to the object than any other member of this second lens group G2 is and that the seventh lens L7 is located closer to the image plane than any other member of this second lens group G2 is. The sixth lens L6 and the seventh lens L7 are bonded together with an adhesive, for example, to form a bonded lens.

The third lens group G3 consists of an eighth lens L8 having negative power.

The respective lenses will be described.

First, the respective lenses that form the first lens group G1 will be described. The first lens L1 is a meniscus lens having a convex surface facing the object. The second lens L2 is a meniscus lens having a convex surface facing the object. Each of the two surfaces of the second lens L2 has an aspheric shape. The third lens L3 is a biconcave lens. The fourth lens L4 is a meniscus lens having a convex surface facing the object.

Next, the respective lenses belonging to the second lens group G2 will be described. The fifth lens L5 is a biconvex lens. Each of the two surfaces of the fifth lens L5 has an aspheric shape. The sixth lens L6 is a biconcave lens. The seventh lens L7 is a biconvex lens.

Next, the lens that forms the third lens group G3 will be described. The eighth lens L8 is a biconcave lens. Each of the two surfaces of the eighth lens L8 has an aspheric shape.

While the imaging optical system according to the third embodiment is zooming from the wide-angle end toward the telephoto end during a shooting session, the first lens group G1, the second lens group G2, and the third lens group G3 all move with respect to the image plane S. In the meantime, as the imaging optical system is zooming from the wide-angle end toward the telephoto end during the shooting session, the first, second and third lens groups G1, G2, G3 move along the optical axis such that the interval between the first lens group G1 and the second lens group G2 decreases, the interval between the second lens group G2 and the third lens group G3 increases, and the interval between the third lens group G3 and the image plane S increases.

While the imaging optical system according to the third embodiment is focusing to make a transition from the infinity in-focus state to the close-object in-focus state, the third lens group G3 moves along the optical axis toward the image plane.

### Fourth Embodiment

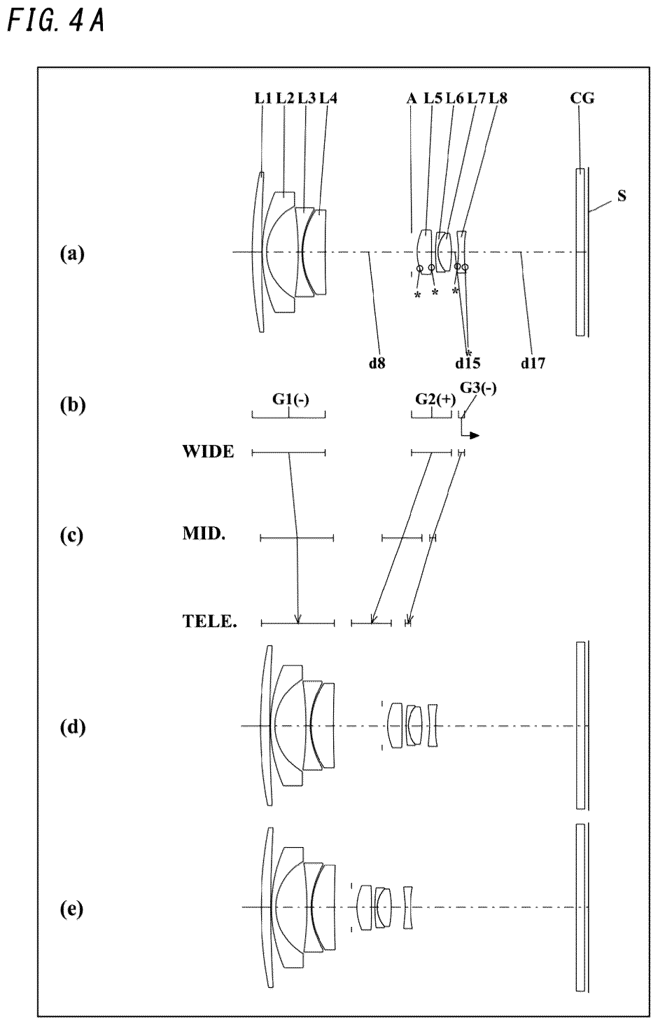

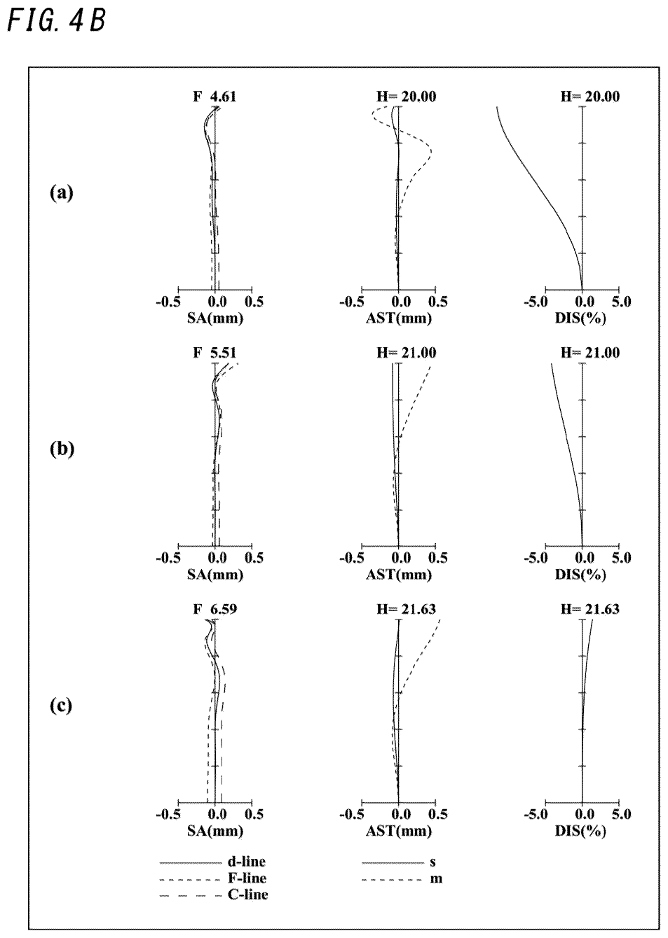

FIG. 4A illustrates an imaging optical system according to a fourth embodiment.

The imaging optical system is made up of: a first lens group G1 having negative power; a second lens group G2 having positive power; and a third lens group G3 having negative power. The first, second, and third lens groups G1, G2, G3 are arranged in this order such that the first lens group G1 is located closer to an object than the second or third lens group G2, G3 is and that the third lens group G3 is located closer to an image plane than the first or second lens group G1, G2 is.

The imaging optical system forms an image at a point on the image plane S.

The first lens group G1 is made up of: a first lens L1 having positive power; a second lens L2 having negative power; a third lens L3 having negative power; and a fourth lens L4 having positive power. The first lens L1, the second lens L2, the third lens L3, and the fourth lens L4 are arranged in this order such that the first lens L1 is located closer to the object than any other member of this first lens group G1 is and that the fourth lens L4 is located closer to the image plane than any other member of this first lens group G1 is.

The second lens group G2 is made up of: an aperture stop A; a fifth lens L5 having positive power; a sixth lens L6 having negative power; and a seventh lens L7 having positive power. The aperture stop A and the fifth, sixth, and seventh lenses L5, L6, L7 are arranged in this order such that the aperture stop A is located closer to the object than any other member of this second lens group G2 is and that the seventh lens L7 is located closer to the image plane than any other member of this second lens group G2 is. The sixth lens L6 and the seventh lens L7 are bonded together with an adhesive, for example, to form a bonded lens

The third lens group G3 consists of an eighth lens L8 having negative power.

The respective lenses will be described.

First, the respective lenses that form the first lens group G1 will be described. The first lens L1 is a meniscus lens having a convex surface facing the object. The second lens L2 is a meniscus lens having a convex surface facing the object. The third lens L3 is a biconcave lens. The fourth lens L4 is a meniscus lens having a convex surface facing the object.

Next, the respective lenses belonging to the second lens group G2 will be described. The fifth lens L5 is a biconvex lens. Each of the two surfaces of the fifth lens L5 has an aspheric shape. The sixth lens L6 is a meniscus lens having a convex surface facing the object. The seventh lens L7 is a biconvex lens.

Next, the lens that forms the third lens group G3 will be described. The eighth lens L8 is a biconcave lens. Each of the two surfaces of the eighth lens L8 has an aspheric shape.

While the imaging optical system according to the fourth embodiment is zooming from the wide-angle end toward the telephoto end during a shooting session, the first lens group G1, the second lens group G2, and the third lens group G3 all move with respect to the image plane S. In the meantime, as the imaging optical system is zooming from the wide-angle end toward the telephoto end during the shooting session, the first, second and third lens groups G1, G2, G3 move along the optical axis such that the interval between the first lens group G1 and the second lens group G2 decreases, the interval between the second lens group G2 and the third lens group G3 increases, and the interval between the third lens group G3 and the image plane S increases.

While the imaging optical system according to the fourth embodiment is focusing to make a transition from the infinity in-focus state toward the close-object in-focus state, the third lens group G3 moves along the optical axis toward the image plane.

### Fifth Embodiment

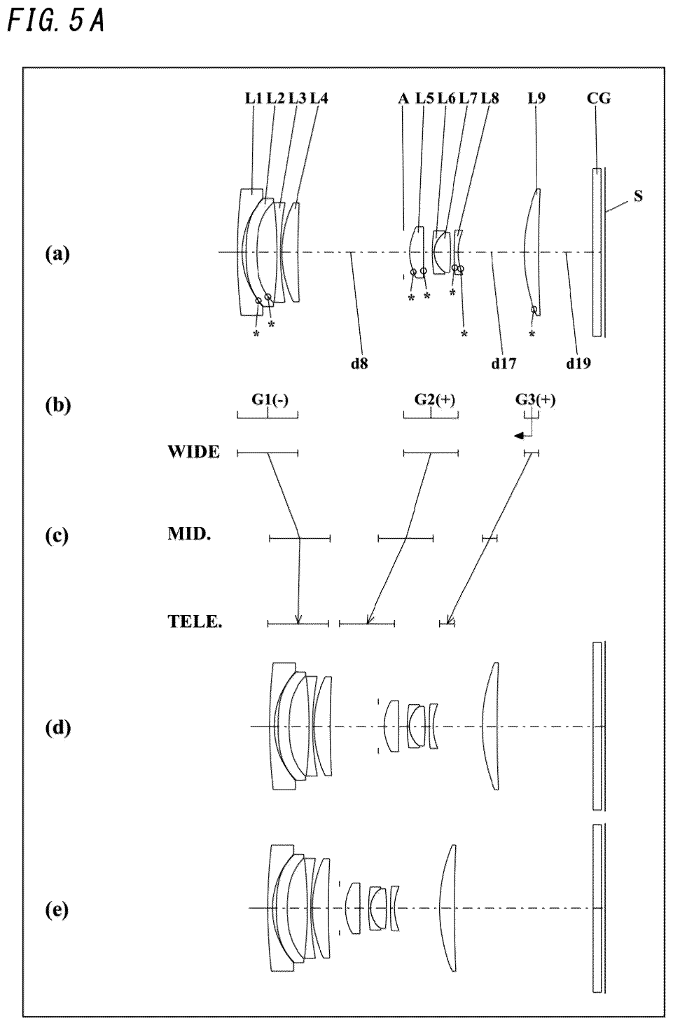

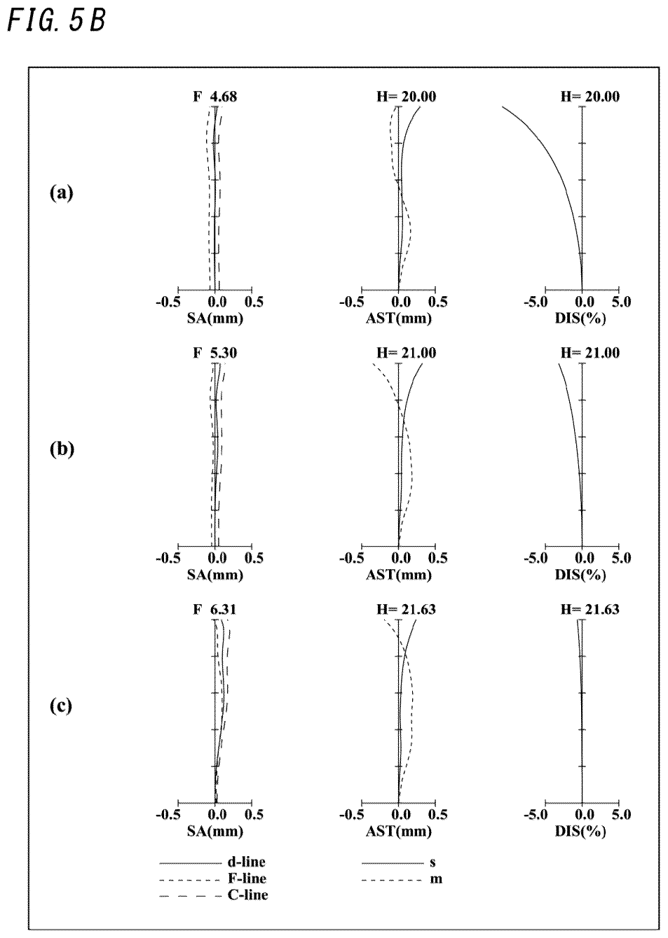

FIG. 5A illustrates an imaging optical system according to a fifth embodiment.

The imaging optical system is made up of: a first lens group G1 having negative power; a second lens group G2 having positive power; and a third lens group G3 having positive power. The first, second, and third lens groups G1, G2, G3 are arranged in this order such that the first lens group G1 is located closer to an object than the second or third lens group G2, G3 is and that the third lens group G3 is located closer to an image plane than the first or second lens group G1, G2 is.

The imaging optical system forms an image at a point on the image plane S.

The first lens group G1 is made up of: a first lens L1 having negative power; a second lens L2 having negative power; a third lens L3 having negative power; and a fourth lens L4 having positive power. The first lens L1, the second lens L2, the third lens L3, and the fourth lens L4 are arranged in this order such that the first lens L1 is located closer to the object than any other member of this first lens group G1 is and that the fourth lens L4 is located closer to the image plane than any other member of this first lens group G1 is.

The second lens group G2 is made up of: an aperture stop A; a fifth lens L5 having positive power; a sixth lens L6 having negative power; a seventh lens L7 having positive power; and an eighth lens L8 having negative power. The aperture stop A and the fifth, sixth, seventh and eighth lenses L5, L6, L7, L8 are arranged in this order such that the aperture stop A is located closer to the object than any other member of this second lens group G2 is and that the eighth lens L8 is located closer to the image plane than any other member of this second lens group G2 is. The sixth lens L6 and the seventh lens L7 are bonded together with an adhesive, for example, to form a bonded lens.

The third lens group G3 consists of a ninth lens L9 having positive power.

The respective lenses will be described.

First, the respective lenses that form the first lens group G1 will be described. The first lens L1 is a meniscus lens having a convex surface facing the object. The second lens L2 is a meniscus lens having a convex surface facing the object. Each of the two surfaces of the second lens L2 has an aspheric shape. The third lens L3 is a biconcave lens. The fourth lens L4 is a meniscus lens having a convex surface facing the object.

Next, the respective lenses belonging to the second lens group G2 will be described. The fifth lens L5 is a biconvex lens. Each of the two surfaces of the fifth lens L5 has an aspheric shape. The sixth lens L6 is a meniscus lens having a convex surface facing the object. The seventh lens L7 is a biconvex lens. The eighth lens L8 is a meniscus lens having a convex surface facing the object. Each of the two surfaces of the eighth lens L8 has an aspheric shape.

Next, the lens that forms the third lens group G3 will be described. The ninth lens L9 is a meniscus lens having a convex surface facing the object. The object-side surface of the ninth lens L9 has an aspheric shape.

While the imaging optical system according to the fifth embodiment is zooming from the wide-angle end toward the telephoto end during a shooting session, the first lens group G1, the second lens group G2, and the third lens group G3 all move with respect to the image plane S. In the meantime, as the imaging optical system is zooming from the wide-angle end toward the telephoto end during the shooting session, the first, second and third lens groups G1, G2, G3 move along the optical axis such that the interval between the first lens group G1 and the second lens group G2 decreases, the interval between the second lens group G2 and the third lens group G3 decreases, and the interval between the third lens group G3 and the image plane S increases.

While the imaging optical system according to the fifth embodiment is focusing to make a transition from the infinity in-focus state toward the close-object in-focus state, the third lens group G3 moves along the optical axis toward the image plane.

### OTHER EMBODIMENTS

The first, second, third, fourth, and fifth embodiments have been described as exemplary embodiments of the present disclosure. Note that the embodiments described above are only examples of the present disclosure and should not be construed as limiting. Rather, each of these embodiments may be readily modified, replaced, combined with other embodiments, provided with some additional components, or partially omitted without departing from the scope of the present disclosure.

For example, in the first to fifth embodiments described above, the imaging optical system is supposed to be used in the entire zoom range from the wide-angle end through the telephoto end. However, the imaging optical system does not have to be used in the entire zoom range. Alternatively, the imaging optical system may also be used selectively only in an extracted range where optical performance is ensured according to the desired zoom range, for example. That is to say, the imaging optical system may also be used as an imaging optical system with lower zoom power than the imaging optical system to be described for the first, second, third, fourth, and fifth examples of numerical values corresponding to the first, second, third, fourth, and fifth embodiments, respectively. Optionally, the imaging optical system may also be used selectively as a single-focus lens system only at an extracted focal length where optical performance is ensured according to the desired zoom position.

In addition, the number of the lens groups and the number of the lenses that form each lens group are substantial numbers. Optionally, a lens having substantially no power may be added to any of the lens groups described above.

### Conditions and Advantages

Next, conditions that may be satisfied by the imaging optical systems according to the first to fifth embodiments, for example, will be described. A plurality of possible conditions may be defined for the imaging optical system according to each of the first to fifth embodiments. In that case, an imaging optical system, of which the configuration satisfies all of these possible conditions, is most advantageous. Alternatively, an imaging optical system that achieves its expected advantages by satisfying any of the individual conditions to be described below may also be provided.

An imaging optical system according to each of the first through fifth embodiments consists of: a first lens group G1 having negative power; a second lens group G2 having positive power; and a third lens group G3 having power. The first, second, and third lens groups G1, G2, G3 are arranged in this order such that the first lens group G1 is located closer to an object than the second or third lens group G2, G3 is, and that the third lens group G3 is located closer to an image plane than the first or second lens group G1, G2 is. The first lens group G1, the second lens group G2, and the third lens group G3 move along an optical axis of the imaging optical system such that an interval between adjacent ones of the first, second, and third lens groups G1, G2, G3 changes while the imaging optical system is zooming from a wide-angle end toward a telephoto end. This configuration will be hereinafter referred to as a “basic configuration.”

The imaging optical system with this basic configuration is configured to not only achieve a wide angle of view at the wide-angle end but also compensate for various types of aberrations sufficiently over the entire zoom range. This allows the various types of aberrations produced by respective lens groups while the imaging optical system is zooming to be compensated for sufficiently. Consequently, an imaging optical system having the ability to compensate for various types of aberrations sufficiently over the entire zoom range may be provided.

The imaging optical system preferably satisfies the following inequality (1):

$$1.85 < L 1 nd \qquad ( 1 )$$

where L1nd is a refractive index of a negative lens located closest to the object.

The condition expressed by this inequality (1) defines the refractive index of a negative lens located closest to the object in the imaging optical system.

Satisfying the inequality (1) allows the overall size of the imaging optical system to be reduced.

Conversely, if L1nd were less than the lower limit set by this inequality (1), then a material with a low refractive index should be selected to make it difficult to compensate for various types of aberrations (e.g., the field curvature, among other things), which is not beneficial.

To enhance the advantage described above, the condition expressed by the following inequalty (1a) is preferably satisfied:

$$1.9 < L 1 nd . \qquad ( 1 a )$$

More preferably, to further enhance the advantage described above, the condition expressed by the following inequality (1b) is satisfied:

$$2. < L 1 nd . \qquad ( 1 b )$$

In an imaging optical system having the basic configuration, for example, the third lens group preferably has negative power.

This allows the imaging optical system having the basic configuration to be further downsized.

In an imaging optical system having the basic configuration, for example, the first lens group G1 preferably consists of three or more lenses.

This allows various types of aberrations (e.g., the distortion and field curvature at the wide-angle end, among other things) to be compensated for sufficiently.

An imaging optical system having the basic configuration preferably satisfies the following inequality (2):

$$0.5 < R 11 / fw < 8. \qquad ( 2 )$$

where R11 is a radius of curvature of an object-side surface of the negative lens located closest to the object, and
fw is a focal length of the imaging optical system at the wide-angle end.

The condition expressed by this inequality (2) defines the ratio of the radius of curvature of an object-side surface of the negative lens located closest to the object to the focal length of the imaging optical system at the wide-angle end.

Satisfying the inequality (2) allows a wide angle of view to be realized at the wide-angle end and also allows the field curvature to be compensated for sufficiently at the wide-angle end.

Conversely, if the R11/fw ratio were less than the lower limit set by this inequality (2), then the radius of curvature would be too small to sufficiently compensate for the field curvature, which is not beneficial. On the other hand, if the R11/fw ratio were greater than the upper limit value set by this inequality (2), then the radius of curvature would increase so much as to cause an increase in the overall lens size, which is not beneficial, either.

To enhance the advantage described above, the condition(s) expressed by one or both of the following inequalities (2a) and (2b) is/are preferably satisfied:

$$1. < R 11 / fw \qquad ( 2 a )$$

$$R 11 / fw < 5. . \qquad ( 2 b )$$

More preferably, to further enhance the advantage described above, the condition(s) expressed by one or both of the following inequalities (2c) and (2d) is/are satisfied:

$$1.5 < R 11 / fw \qquad ( 2 c )$$

$$R 11 / fw < 2. . \qquad ( 2 d )$$

In an imaging optical system having the basic configuration, for example, the first lens group G1 preferably includes two or more negative lenses. The imaging optical system preferably satisfies the following inequality (3):

$$60 < L 1 vd < 100 \qquad ( 3 )$$

where L1νd is an abbe number of one of the two or more negative lenses belonging to the first lens group G1.

The condition expressed by this inequality (3) defines an abbe number of one of two or more negative lenses belonging to the first lens group G1 in the imaging optical system.

Satisfying the inequality (3) allows various types of aberrations (e.g., chromatic aberration of magnification, among other things) to be compensated for effectively.

Conversely, if L1νd were less than the lower limit value set by this inequality (3), high-dispersion glass would have to be selected as a material for the negative lenses included in the first lens group G1 to make it difficult to compensate for chromatic aberration, which is not beneficial. On the other hand, if L1νd were greater than the upper limit value set by this inequality (3), then a material with a low refractive index should be selected as a material for the negative lenses included in the first lens group G1 to make it difficult to compensate for the field curvature, which is not beneficial, either.

To enhance the advantage described above, the condition(s) expressed by one or both of the following inequalities (3a) and (3b) is/are preferably satisfied:

$$70 < L 1 vd \qquad ( 3 a )$$

$$L 1 vd < 90. \qquad ( 3 b )$$

More preferably, to further enhance the advantage described above, the condition(s) expressed by one or both of the following inequalities (3c) and (3d) is/are satisfied:

$$75 < L 1 vd \qquad ( 3 c )$$

$$L 1 vd < 80. \qquad ( 3 d )$$

The imaging optical system preferably satisfies the following inequality (4):

$$0.1 < G 1 L / Lt < 0.4 \qquad ( 4 )$$

where G1L is a total thickness of the first lens group G1, and
Lt is a total optical length of the imaging optical system at the telephoto end.

The condition expressed by this inequality (4) defines, for the imaging optical system, the ratio of the total thickness of the first lens group G1 (i.e., a distance measured on the optical axis between an object-side surface of a lens located closer to the object than any other lens belonging to the first lens group G1 and an image-side surface of a lens located closer to the image plane than any other lens belonging to the first lens group G1) to the total optical length of the imaging optical system at the telephoto end (i.e., a distance measured on the optical axis between an object-side surface of a lens located closer to the object than any other member of the imaging optical system and the image plane S).

Satisfying this inequality (4) allows the length of the lens barrel to be reduced when the lens barrel collapses.

Conversely, if the G1L/Lt ratio were less than the lower limit value set by this inequality (4), then the total thickness of the first lens group G1 would be too small to compensate for various types of aberrations smoothly, which is not beneficial. On the other hand, if the G1L/Lt ratio were greater than the upper limit value set by this inequality (4), then the lens barrel would be too long when collapsing, which is not beneficial, either.

To enhance the advantage described above, the condition(s) expressed by one or both of the following inequalities (4a) and (4b) is/are preferably satisfied:

$$0.15 < G 1 L / Lt \qquad ( 4 a )$$

$$G 1 L / Lt < 0.35 . \qquad ( 4 b )$$

More preferably, to further enhance the advantage described above, the condition(s) expressed by one or both of the following inequalities (4c) and (4d) is/are satisfied:

$$0.2 < G 1 L / Lt \qquad ( 4 c )$$

$$G 1 L / Lt < 0.25 . \qquad ( 4 d )$$

In an imaging optical system having the basic configuration, for example, the first lens group preferably moves to draw a locus that is convex toward the image plane while the imaging optical system is zooming from the wide-angle end toward the telephoto end.

This allows a zoom camcorder to have a shorter dimension as measured along the optical axis and also allows the lens barrel to have a smaller length when collapsing.

The imaging optical system preferably satisfies the following inequality (5):

$$0.5 < \vert f 1 / fw \vert < 3. 0 \qquad ( 5 )$$

where f1 is a focal length of the first lens group G1, and
fw is a focal length of the imaging optical system at the wide-angle end.

The condition expressed by this inequality (5) defines the ratio of the focal length of the first lens group G1 to the focal length of the imaging optical system at the wide-angle end.

Satisfying this inequality (5) allows a wide angle of view to be achieved at the wide-angle end and also allows various types of aberrations to be compensated for sufficiently.

Conversely, if |f1/fw| were less than the lower limit value set by this inequality (5), then the refractive power of the first lens group G1 would be too high to compensate for various types of aberrations smoothly, which is not beneficial. On the other hand, if |f1/fw| were greater than the upper limit value set by this inequality (5), then the refractive power of the first lens group G1 would be so low as to cause an increase in the size of the lens barrel, which is not beneficial, either.

To enhance the advantage described above, the condition(s) expressed by one or both of the following inequalities (5a) and (5b) is/are preferably satisfied:

$$1. < \vert f 1 / fw \vert \qquad ( 5 a )$$

$$\vert f 1 / fw \vert < 2. . \qquad ( 5 b )$$

More preferably, to further enhance the advantage described above, the condition(s) expressed by one or both of the following inequalities (5c) and (5d) is/are satisfied:

$$1.3 < \vert f 1 / fw \vert \qquad ( 5 c )$$

$$\vert f 1 / fw \vert < 1.5 . \qquad ( 5 d )$$

In an imaging optical system having the basic configuration, the second lens group G2 preferably includes one or more positive lenses. The imaging optical system preferably satisfies the following inequality (6):

$$65 < L 2 vd < 100 \qquad ( 6 )$$

where L2νd is an abbe number of at least one positive lens belonging to the one or more positive lenses included in the second lens group G2.

The condition expressed by this inequality (6) defines an abbe number of at least one positive lens belonging to the one or more positive lenses included in the second lens group G2.

Satisfying the inequality (6) allows various types of aberrations (e.g., chromatic aberration of magnification, among other things) to be compensated for effectively.

Conversely, if L2νd were less than the lower limit value set by this inequality (6), high-dispersion glass would have to be selected as a material for the positive lens included in the second lens group G2 to make it difficult to compensate for chromatic aberration, which is not beneficial. On the other hand, if L2νd were greater than the upper limit value set by this inequality (6), then a material with a low refractive index should be selected as a material for the positive lens included in the second lens group G2 to make it difficult to compensate for the spherical aberration, which is not beneficial, either.

To enhance the advantage described above, the condition(s) expressed by one or both of the following inequalities (6a) and (6b) is/are preferably satisfied:

$$70 < L 2 vd \qquad ( 6 a )$$

$$L 2 vd < 90. \qquad ( 6 b )$$

More preferably, to further enhance the advantage described above, the condition(s) expressed by one or both of the following inequalities (6c) and (6d) is/are satisfied:

$$80 < L 2 vd \qquad ( 6 c )$$

$$L 2 vd < 85. \qquad ( 6 d )$$

In the imaging optical system, for example, the second lens group G2 preferably includes an aperture stop A located closer to the object than any other member of the second lens group G2 is. The imaging optical system preferably satisfies the following inequality (7):

$$0.05 < G 2 L / Lt < 0.25 \qquad ( 7 )$$

where G2L is a total thickness of the second lens group G2, and
Lt is a total optical length of the imaging optical system at the telephoto end.

The condition expressed by this inequality (7) defines, for the imaging optical system, the ratio of the total thickness of the second lens group G2 (i.e., a distance measured on the optical axis between the aperture stop A and an image-side surface of a lens located closer to the image plane than any other member of the second lens group G2 is) to the total optical length of the imaging optical system at the telephoto end (i.e., a distance measured on the optical axis between an object-side surface of a lens located closer to the object than any other member of the imaging optical system is and the image plane S).

Satisfying this inequality (7) allows the length of the lens barrel to be reduced when the lens barrel collapses.

Conversely, if the G2L/Lt ratio were less than the lower limit value set by this inequality (7), then the total thickness of the second lens group G2 of the imaging optical system would be too small to compensate for various types of aberrations smoothly, which is not beneficial. On the other hand, if the G2L/Lt ratio were greater than the upper limit value set by this inequality (7), then the lens barrel would be too long when collapsing, which is not beneficial, either.

To enhance the advantage described above, the condition(s) expressed by one or both of the following inequalities (7a) and (7b) is/are preferably satisfied:

$$0.10 < G 2 L / Lt \qquad ( 7 a )$$

$$G 2 L / Lt < 0.2 . \qquad ( 7 b )$$

More preferably, to further enhance the advantage described above, the condition(s) expressed by one or both of the following inequalities (7c) and (7d) is/are satisfied:

$$0.12 < G 2 L / Lt \qquad ( 7 c )$$

$$G 2 L / Lt < 0 \text{.15} . \qquad ( 7 d )$$

In an imaging optical system having the basic configuration, for example, the second lens group G2 preferably includes: a lens having positive power; a lens having negative power; and another lens having positive power. These three lenses are arranged in this order such that one of the lenses, each having positive power, of the second lens group is located closer to the object than the remaining two lenses of the second lens group are.

This allows various types of aberrations to be compensated for sufficiently.

In the imaging optical system, the second lens group G2 preferably includes an aperture stop A arranged to be located closer to the object than any other member of the second lens group G2 and configured to move along with the other members of the second lens group G2.

This allows the lens diameter of the first lens group G1 to be reduced and also allows the number of constituent members that form the camcorder to be reduced as well, thus allowing the lens barrel to have a smaller size.

The imaging optical system preferably satisfies, for example, the following inequality (8):

$$0.05 < G 2 m / Lt < 0.4 \qquad ( 8 )$$

where G2m is the magnitude of movement of the second lens group G2 while the imaging optical system is zooming from the wide-angle end toward the telephoto end, and
Lt is a total optical length of the imaging optical system at the telephoto end.

The condition expressed by this inequality (8) defines the ratio of the magnitude of movement of the second lens group G2 while the imaging optical system is zooming from the wide-angle end toward the telephoto end to the total optical length of the imaging optical system at the telephoto end (i.e., the distance measured on the optical axis between the object-side surface of a lens located closest to the object in the imaging optical system and the image plane S).

Satisfying this inequality (8) allows the camcorder barrel to be shortened, thus allowing the length of the lens barrel collapsing to be reduced.

Conversely, if the G2m/Lt ratio were less than the lower limit set by this inequality (8), then the refractive power of the second lens group G2 would be too high to compensate for various types of aberrations, which is not beneficial. On the other hand, if the G2m/Lt ratio were greater than the upper limit value set by this inequality (8), then the length of the lens barrel collapsing would increase, which is not beneficial, either.

To enhance the advantage described above, the condition(s) expressed by one or both of the following inequalities (8a) and (8b) is/are preferably satisfied:

$$0.10 < G 2 m / Lt \qquad ( 8 a )$$

$$G 2 m / Lt < 0 \text{.30} . \qquad ( 8 b )$$

More preferably, to further enhance the advantage described above, the condition(s) expressed by one or both of the following inequalities (8c) and (8d) is/are satisfied:

$$0.14 < G 2 m / Lt \qquad ( 8 c )$$

$$G 2 m / Lt < 0.2 . \qquad ( 8 d )$$

In an imaging optical system having the basic configuration, the third lens group G3 preferably consists of a single lens.

Making the third lens group G3 up of a single lens allows the weight of the third lens group G3 to be reduced, thus making it easier to find a focus more quickly.

The imaging optical system preferably satisfies the following inequality (9):

$$L 3 nd < 1.65 \qquad ( 9 )$$

where L3n is a refractive index of the single lens that forms the third lens group G3.

The condition expressed by this inequality (9) defines a refractive index of a single lens that forms the third lens group G3 in the imaging optical system.

Satisfying this inequality (9) allows the weight of the third lens group G3 to be reduced, thus making it easier to find a focus more quickly.

Conversely if L3nd were greater than the upper limit value set by this inequality (9), then a glass material should be selected as a material for the single lens that forms the third lens group G3 to cause an increase in the weight of the focus lens.

To enhance the advantage described above, the condition expressed by the following inequality (9a) is preferably satisfied:

$$L 3 nd < 1 \text{.60} . \qquad ( 9 a )$$

More preferably, to further enhance the advantage described above, the condition expressed by the following inequality (9b) is satisfied:

$$L 3 nd < 1.55 . \qquad ( 9 b )$$

In addition, the imaging optical system preferably satisfies not only any one of the inequalities (9), (9a), and (9b) but also the following inequality (10):

$$L 3 vd < 65 \qquad ( 10 )$$

where L3νd is an abbe number of a single lens that forms the third lens group G3.

The condition expressed by this inequality (10) defines an abbe number of a single lens that forms the third lens group G3 in the imaging optical system.

Satisfying this inequality (10) allows the weight of the third lens group G3 to be reduced, thus making it easier to find a focus more quickly.

Conversely, if L3νd were greater than the upper limit value set by this inequality (10), then a glass material should be selected as a material for the single lens that forms the third lens group G3 to cause an increase in the weight of the focus lens.

To enhance the advantage described above, the condition expressed by the following inequality (10a) is preferably satisfied:

$$L 3 vd < 60. \qquad ( 10 a )$$

More preferably, to further enhance the advantage described above, the condition expressed by the following inequality (10b) is satisfied:

$$L 3 vd < 56. \qquad ( 10 b )$$

The imaging optical system preferably satisfies, for example, the following inequality (11):

$$0.3 < \vert f 3 / fw \vert < 2.5 \qquad ( 11 )$$

where f3 is a focal length of the third lens group G3, and
fw is a focal length of the imaging optical system at the wide-angle end.

The condition expressed by this inequality (11) defines the ratio of focal length of the third lens group G3 of the imaging optical system to a focal length of the imaging optical system at the wide-angle end.

Satisfying this inequality (11) allows the best balance to be struck between the focusing speed and the stop accuracy.

Conversely, if |f3/fw| were less than the lower limit value set by this inequality (11), then the power of the focus group would increase so much as to cause a decline in the stop accuracy, which is not beneficial. On the other hand, if |f3/fw| were greater than the upper limit value set by this inequality (11), then the power of the focus group would decrease so much as to cause a decline in speed, which is not beneficial, either.

To enhance the advantage described above, the condition(s) expressed by one or both of the following inequalities (11a) and (11b) is/are preferably satisfied:

$$0.7 < \vert f 3 / fw \vert \qquad ( 11 a )$$

$$\vert f 3 / fw \vert < 1.7 . \qquad ( 11 b )$$

More preferably, to further enhance the advantage described above, the condition(s) expressed by one or both of the following inequalities (11c) and (11d) is/are satisfied:

$$1. < \vert f 3 / fw \vert \qquad ( 11 c )$$

$$\vert f 3 / fw \vert < 1.5 . \qquad ( 11 d )$$

The imaging optical system preferably satisfies the following inequality (12):

$$0.2 < LTt / Lt < 0.8 \qquad ( 12 )$$

where LTt is a total lens length of the imaging optical system at the telephoto end, and
Lt is a total optical length of the imaging optical system at the telephoto end.

The condition expressed by this inequality (12) defines the ratio of a total lens length of the imaging optical system at the telephoto end (i.e., the distance measured on the optical axis between an object-side surface of a lens located closest to the object in the imaging optical system and an image-side surface of a lens located closest to the image plane) to a total optical length of the imaging optical system at the telephoto end (i.e., the distance measured on the optical axis between an object-side surface of the lens located closest to the object in the imaging optical system and the image plane S).

Satisfying the inequality (12) allows the length of the lens barrel collapsing to be reduced.

Conversely, if the LTt/Lt ratio were less than the lower limit set by this inequality (12), then the total lens length of the imaging optical system would be too short at the telephoto end to achieve sufficient resolution performance, which is not beneficial. On the other hand, if the LTt/Lt ratio were greater than the upper limit value set by this inequality (12), then the lens barrel collapsing would be too long, which is not beneficial, either.

To enhance the advantage described above, the condition(s) expressed by one or both of the following inequalities (12a) and (12b) is/are preferably satisfied:

$$0.3 < LTt / Lt \qquad ( 12 a )$$

$$LTt / Lt < 0.7 . \qquad ( 12 b )$$

More preferably, to further enhance the advantage described above, the condition(s) expressed by one or both of the following inequalities (12c) and (12d) is/are satisfied:

$$0.4 < LTt / Lt \qquad ( 12 c )$$

$$LTt / Lt < 0.5 . \qquad ( 12 d )$$

The imaging optical system preferably satisfies the following inequality (13):

$$0.5 < BFw / Yw < 2.5 \qquad ( 13 )$$

where BFw is a back focus of the imaging optical system at the wide-angle end, and
Yw is an image height of the imaging optical system at the wide-angle end.

The condition expressed by this inequality (13) defines the ratio of a back focus of the imaging optical system at the wide-angle end (i.e., the distance measured on the optical axis between an image-side surface of a lens located closest to the image plane and the image plane S) to an image height of the imaging optical system at the wide-angle end.

Satisfying this inequality (13) allows the imaging optical system to be downsized.

Conversely, if the BFw/Yw ratio were less than the lower limit set by this inequality (13), then the back focus would be so short as to cause interference between the lens and the image capturing plane frequently, which is not beneficial. On the other hand, if the BFw/Yw ratio were greater than the upper limit value set by this inequality (13), then the back focus would be so long as to cause a significant increase in the overall size of the lens, which is not beneficial, either.

To enhance the advantage described above, the condition(s) expressed by one or both of the following inequalities (13a) and (13b) is/are preferably satisfied:

$$1. < BFw / Yw \qquad ( 13 a )$$

$$BFw / Yw < 2. . \qquad ( 13 b )$$

More preferably, to further enhance the advantage described above, the condition(s) expressed by one or both of the following inequalities (13c) and (13d) is/are satisfied:

$$1.4 < BFw / Yw \qquad ( 13 c )$$

$$BFw / Yw < 1.6 . \qquad ( 13 d )$$

The imaging optical system preferably satisfies the following inequality (14):

$$0.6 < Lt / Lw < 1.2 \qquad ( 14 )$$

where Lt is a total optical length of the imaging optical system at the telephoto end, and
Lw is a total optical length of the imaging optical system at the wide-angle end.

The condition expressed by this inequality (14) defines the ratio of a total optical length of the imaging optical system at the telephoto end (i.e., the distance measured on the optical axis between an object-side surface of a lens located closest to the object in the imaging optical system and the image plane S) to a total optical length of the imaging optical system at the wide-angle end (i.e., the distance measured on the optical axis between the object-side surface of the lens located closest to the object in the imaging optical system and the image plane S).

Satisfying the inequality (14) allows the dimension of a zoom camcorder as measured along the optical axis to be further reduced, thus allowing the length of the lens barrel collapsing to be reduced as well.

Conversely, if the Lt/Lw ratio were less than the lower limit value set by this inequality (14), then the total lens length of the imaging optical system at the telephoto end would be so short as to make it difficult to increase the variable magnification ratio, which is not beneficial. On the other hand, if the Lt/Lw ratio were greater than the upper limit value set by this inequality (14), then the dimension of a zoom camcorder as measured along the optical axis would increase, thus causing an increase in the overall size of the lens, which is not beneficial, either.

To enhance the advantage described above, the condition(s) expressed by one or both of the following inequalities (14a) and (14b) is/are preferably satisfied:

$$0.8 < Lt / Lw \qquad ( 14 a )$$

$$Lt / Lw < 1.1 . \qquad ( 14 b )$$

More preferably, to further enhance the advantage described above, the condition(s) expressed by one or both of the following inequalities (14c) and (14d) is/are satisfied:

$$0.9 < Lt / Lw \qquad ( 14 c )$$

$$Lt / Lw < 1. . \qquad ( 14 d )$$

(Schematic Configuration for Image Capture Device to which First Embodiment is Applied)

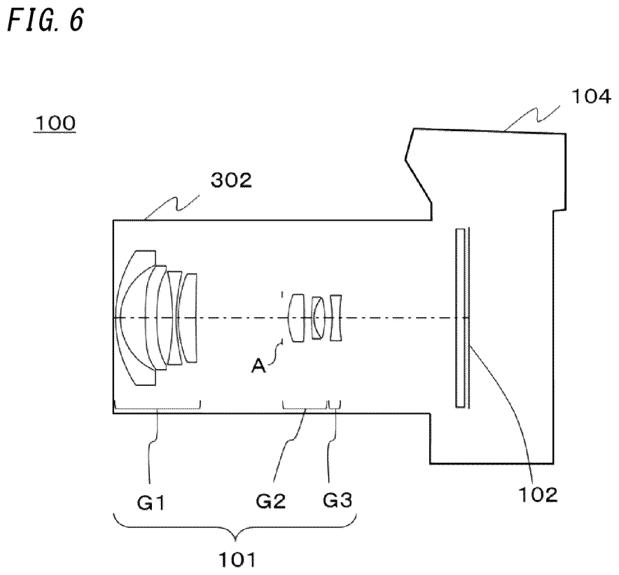

FIG. 6 illustrates a schematic configuration for an image capture device, to which the imaging optical system according to the first embodiment is applied. Alternatively, the imaging optical system according to the second, third, fourth, or fifth embodiment is also applicable to the image capture device.

The image capture device 100 includes a housing 104, an image sensor 102, and the imaging optical system 101 according to the first embodiment. Specifically, the image capture device 100 may be implemented as a digital camera, for example.

The housing 104 includes a lens barrel 302. The lens barrel 302 holds the respective lens groups (including the aperture stop A) that form the imaging optical system 101.

The image sensor 102 is disposed at the image plane S of the imaging optical system according to the first embodiment.

In the imaging optical system 101, the first lens group G1, the second lens group G2, and the third lens group G3 are attached to, or engaged with, a lens frame included in the lens barrel 302 so as to move while the imaging optical system 101 is zooming.

In the image capture device 100 including the imaging optical system 101 that includes the respective lens groups held by the lens barrel 302, an actuator, a lens frame, and other members to be controlled by the controller in the image capture device 100 are provided such that the third lens group G3 may move while the imaging optical system 101 is focusing.

This provides an image capture device with the ability to compensate for various types of aberrations sufficiently.

In the example described above, the imaging optical system according to the first embodiment is applied to a digital camera. However, this is only an example and should not be construed as limiting. Alternatively, the imaging optical system is also applicable to a digital camcorder, a surveillance camera, a smartphone, or any of various other types of image capture devices.

(Schematic Configuration for Camera System to which First Embodiment is Applied)

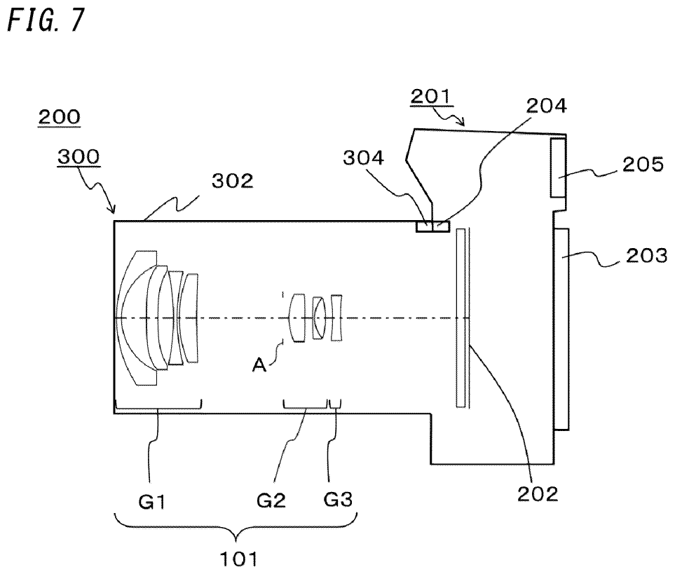

FIG. 7 illustrates a schematic configuration for a camera system, to which the imaging optical system according to the first embodiment is applied. Alternatively, the imaging optical system according to the second, third, fourth, or fifth embodiment is also applicable to the camera system.

The camera system 200 includes a camera body 201 and an interchangeable lens unit 300 to be connected removably to the camera body 201.

The camera body 201 includes an image sensor 202, a monitor 203, a memory, a camera mount 204, and a viewfinder 205. The image sensor 202 receives an optical image of an object formed by the imaging optical system 101 of the interchangeable lens unit 300 and transforms the optical image into an electrical image signal. The monitor 203 displays the electrical image signal transformed by the image sensor 202. The memory stores the electrical image signal.

The imaging optical system 101 of the interchangeable lens unit 300 is the imaging optical system according to the first embodiment.

The interchangeable lens unit 300 includes not only the imaging optical system 101 but also a lens barrel 302 and a lens mount 304 as well. The lens barrel 302 holds the respective lens groups and aperture stop A that form the imaging optical system 101. The lens mount 304 is to be connected to the camera mount 204 of the camera body 201.

The camera mount 204 and the lens mount 304 are physically connected together. In addition, the camera mount 204 and the lens mount 304 also electrically connect together a controller in the camera body 201 and a controller in the interchangeable lens unit 300. That is to say, the camera mount 204 and the lens mount 304 serve as interfaces that allow themselves to exchange signals with each other.

In the imaging optical system 101, the first lens group G1, the second lens group G2, and the third lens group G3 are attached to, or engaged with, a lens frame included in the lens barrel 302 so as to be movable while the imaging optical system 101 is zooming.

In the camera system 200 including the respective lens groups held by the lens barrel 302 and the camera body 201, an actuator, a lens frame, and other members to be controlled by the controller in the interchangeable lens unit 300 are provided such that the third lens group G3 may move while the imaging optical system 101 is focusing.

This allows for providing an image capture device having the ability to compensate for various types of aberrations sufficiently.

In the example described above, the imaging optical system according to the first embodiment is applied to a digital camera. However, this is only an example and should not be construed as limiting. Alternatively, the imaging optical system according to the first embodiment is also applicable to a digital camcorder, a surveillance camera, a smartphone, and various other image capture devices.

### (Examples of Numerical Values)

Next, exemplary sets of specific numerical values that were actually adopted in the imaging optical systems with the configurations according to the first, second, third, fourth, and fifth embodiments will be described. Note that in the tables showing these exemplary sets of numerical values, the length is expressed in millimeters (mm), the angle of view is expressed in degrees (°), r indicates the radius of curvature, d indicates the surface interval, nd indicates a refractive index in response to a d-line, υd (also denoted as “νd”) indicates an abbe number in response to a d-line, and a surface with an asterisk (*) is an aspheric surface. The aspheric shape is defined by the following equation:

$$Z = \frac{{h}^{2} / r}{1 + \sqrt{1 - ( 1 + κ ) {( h / r )}^{2}}} + \sum {A}_{n} {h}^{n}$$

where Z is the distance from a point on an aspheric surface, located at a height h measured from the optical axis, to a tangent plane defined with respect to the vertex of the aspheric surface, h is the height as measured from the optical axis, r is the radius of curvature of the vertex, κ is a conic constant, and An is an n^{th} order aspheric surface coefficient.

FIGS. 1B, 2B, 3B, 4B, and 5B are longitudinal aberration diagrams showing what state the imaging optical systems according to the first, second, third, fourth, and fifth embodiments assume in the infinity in-focus state.

In each longitudinal aberration diagram, portion (a) shows the longitudinal aberrations at the wide-angle end, portion (b) shows the longitudinal aberrations at the middle position, and portion (c) shows the longitudinal aberrations at the telephoto end. Each of portions (a), (b) and (c) of these longitudinal aberration diagrams shows spherical aberration (SA (mm)), astigmatism (AST (mm)), and distortion (DIS (%)) in this order from left to right. In each spherical aberration diagram, the ordinate indicates the F number (designated by “F” on the drawings), the solid curve indicates a characteristic in response to a d-line, the shorter dashed curve indicates a characteristic in response to an F-line, and the longer dashed curve indicates a characteristic in response to a C-line. In each astigmatism diagram, the ordinate indicates the image height (designated by “H” on the drawings), the solid curve indicates a characteristic with respect to a sagittal plane (designated by “s” on the drawings), and the dotted curve indicates a characteristic with respect to a meridional plane (designated by “m” on the drawings). Furthermore, in each distortion diagram, the ordinate indicates the image height (designated by “H” on the drawings).

### (First Example of Numerical Values)

Following is a first exemplary set of numerical values for the imaging optical system corresponding to the first embodiment shown in FIG. 1A. Specifically, as the first example of numerical values for the imaging optical system, surface data is shown in Table 1A, aspheric surface data is shown in Table 1B, and various types of data in the infinity in-focus state are shown in Tables 1C-1F.

TABLE 1A
(Surface data)

| Surface No. | r | d | nd | vd |
|---|---|---|---|---|
| Object surface | ∞ | | | |
| 1 | 29.72970 | 1.20000 | 2.00100 | 29.1 |
| 2 | 14.05380 | 6.07960 | | |
| 3* | 320.00000 | 2.80000 | 1.53380 | 55.6 |
| 4* | 92.08330 | 3.78540 | | |
| 5 | −52.34240 | 0.90000 | 1.59283 | 68.6 |
| 6 | 45.03730 | 0.49090 | | |
| 7 | 28.48860 | 4.24410 | 1.80809 | 22.8 |
| 8 | 258.32790 | Variable | | |
| 9 (Aperture) | ∞ | 1.50000 | | |
| 10* | 13.20250 | 3.90000 | 1.80610 | 40.7 |
| 11* | −300.00000 | 1.82520 | | |
| 12 | 93.04890 | 0.50000 | 1.80610 | 33.3 |
| 13 | 7.23310 | 0.01000 | 1.56732 | 42.8 |
| 14 | 7.23310 | 2.70400 | 1.49700 | 81.6 |
| 15 | −20.30710 | Variable | | |
| 16* | −25.79700 | 1.90000 | 1.53380 | 55.6 |
| 17* | 120.00000 | Variable | | |
| 18 | ∞ | 2.10000 | 1.51680 | 64.2 |
| 19 | ∞ | 1.00000 | | |
| Image plane | | | | |

TABLE 1B
(Aspheric surface data)

3^{rd} surface
K = 8.62779E−01, A4 = 8.76762E−05, A6 = 1.80523E−07, A8 = −4.82966E−09
A10 = 5.06456E−11, A12 = −2.26364E−13, A14 = 3.77768E−16
4^{th} surface
K = 9.94897E−01, A4 = 8.50255E−05, A6 = 4.36081E−07, A8 = −1.18646E−08
A10 = 1.41878E−10, A12 = −7.94806E−13, A14 = 1.58526E−15
10^{th} surface
K = 0.00000E+00, A4 = −6.53783E−05, A6 = −2.36530E−07, A8 = −7.14212E−08
A10 = 1.77714E−09, A12 = −3.27660E−11, A14 = 0.00000E+00
11^{th} surface
K = 0.00000E+00, A4 = −3.40712E−05, A6 = −2.20996E−06, A8 = 2.63690E−08
A10 = −1.42969E−09, A12 = 8.16354E−12, A14 = 0.00000E+00
16^{th} surface
K = 0.00000E+00, A4 = 4.09073E−04, A6 = −2.52089E−05, A8 = 1.70938E−06
A10 = 6.51792E−08, A12 = 9.89011E−10, A14 = 0.00000E+00
17^{th} surface
K = 0.00000E+00, A4 = 4.31564E−04, A6 = −1.95480E−05, A8 = 1.19295E−06
A10 = −4.78744E−08, A12 = 9.90203E−10, A14 = −8.03075E−12
(Various types of data in infinity in-focus state)

TABLE 1C
(Various types of data)
(Zoom ratio: 2.04640)

| | Wide-angle | Middle | Telephoto |
|---|---|---|---|
| Focal length | 18.8119 | 26.9018 | 38.4968 |
| F number | 4.51734 | 5.38496 | 6.54366 |
| Angle of view | 49.9560 | 38.6973 | 29.0433 |
| Image height | 20.0000 | 21.0000 | 21.6330 |
| Total optical length | 85.8995 | 83.0618 | 84.4826 |
| d8 | 20.9499 | 10.6965 | 2.9333 |
| d15 | 1.7994 | 2.0527 | 3.0078 |
| d17 | 28.2110 | 35.3734 | 43.6023 |
| Entrance pupil position | 16.1941 | 14.0397 | 11.7232 |
| Exit pupil position | −39.6525 | −46.9749 | −55.7930 |
| Anterior principal point | 26.0812 | 25.5164 | 23.6520 |
| Posterior principal point | 67.0870 | 56.1028 | 45.9745 |

TABLE 1D
(Data about single lenses)

| Lens | Start surface | Focal length |
|---|---|---|
| 1 | 1 | −27.6869 |
| 2 | 3 | −243.2401 |
| 3 | 5 | −40.6948 |
| 4 | 7 | 39.2998 |
| 5 | 10 | 15.7755 |
| 6 | 12 | −9.7546 |
| 7 | 14 | 11.0929 |
| 8 | 16 | −39.5965 |

TABLE 1E
(Data about zoom lens groups)

| | | | Lens | Anterior | Posterior |
|---|---|---|---|---|---|
| | Start | | configuration | principal | principal |
| Group | surface | Focal length | length | point | point |
| 1 | 1 | −25.45755 | 19.50000 | 1.37841 | 5.00755 |
| 2 | 9 | 18.24439 | 10.43920 | 1.74368 | 4.29311 |
| 3 | 16 | −39.59645 | 1.90000 | 0.21819 | 0.88503 |

TABLE 1F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 9 | −0.41092 | −0.53431 | −0.69153 |
| 3 | 16 | 1.79830 | 1.97775 | 2.18673 |

### (Second Example of Numerical Values)

Following is a second exemplary set of numerical values for the imaging optical system corresponding to the second embodiment shown in FIG. 2A. Specifically, as the second example of numerical values for the imaging optical system, surface data is shown in Table 2A, aspheric surface data is shown in Table 2B, and various types of data in the infinity in-focus state are shown in Tables 2C-2F.

TABLE 2A
(Surface data)

| Surface No. | r | d | nd | vd |
|---|---|---|---|---|
| Object surface | ∞ | | | |
| 1 | 37.24840 | 1.20000 | 1.90366 | 31.3 |
| 2 | 15.67780 | 4.81900 | | |
| 3* | 325.00000 | 2.80000 | 1.53380 | 55.6 |
| 4* | 483.93620 | 3.57370 | | |
| 5 | −52.60720 | 0.90000 | 1.59283 | 68.6 |
| 6 | 35.97690 | 1.03590 | | |
| 7 | 28.18300 | 3.57480 | 1.80518 | 25.5 |
| 8 | 182.25580 | Variable | | |
| 9 (Aperture) | ∞ | 1.50000 | | |
| 10* | 12.92780 | 3.70000 | 1.80998 | 40.9 |
| 11* | −300.00000 | 1.53260 | | |
| 12 | 93.97250 | 0.50000 | 1.80610 | 33.3 |
| 13 | 7.49460 | 0.01000 | 1.56732 | 42.8 |
| 14 | 7.49460 | 3.85740 | 1.49700 | 81.6 |
| 15 | −21.39470 | Variable | | |
| 16* | −22.86130 | 1.80000 | 1.58313 | 59.5 |
| 17* | 120.00000 | Variable | | |
| 18 | ∞ | 2.10000 | 1.51680 | 64.2 |
| 19 | ∞ | 1.00000 | | |
| Image plane | ∞ | | | |

TABLE 2B
(Aspheric surface data)

3^{rd} surface
K = 1.00000E+00, A4 = 6.62444E−05, A6 = 1.98979E−09, A8 = 2.28777E−10
A10 = 4.77023E−12, A12 = −3.65710E−14, A14 = 1.15964E−16
4^{th} surface
K = −1.00000E+00, A4 = 7.32903E−05, A6 = −1.07423E−07, A8 = 2.39063E−09
A10 = −1.19083E−11, A12 = 2.97383E−14, A14 = 3.73967E−17
10^{th} surface
K = 0.00000E+00, A4 = −3.37865E−05, A6 = −5.39579E−07, A8 = −1.33018E−08
A10 = 2.05327E−10, A12 = −9.96535E−12, A14 = 0.00000E+00
11^{th} surface
K = 0.00000E+00, A4 = 9.56450E−06, A6 = −1.44964E−06, A8 = 2.65402E−08
A10 = −1.18038E−09, A12 = 6.46899E−12, A14 = 0.00000E+00
16^{th} surface
K = 0.00000E+00, A4 = 4.17495E−04, A6 = −1.14683E−05, A8 = 4.42428E−07
A10 = −1.40695E−08, A12 = 1.94878E−10, A14 = 0.00000E+00
17^{th} surface
K = 0.00000E+00, A4 = 4.33760E−04, A6 = −6.14512E−06, A8 = −5.96226E−08
A10 = 1.07752E−08, A12 = −3.95163E−10, A14 = 4.98466E−12
(Various types of data in infinity in-focus state)

TABLE 2C
(Various types of data)
(Zoom ratio: 2.07060)

| | Wide-angle | Middle | Telephoto |
|---|---|---|---|
| Focal length | 20.9036 | 30.0642 | 43.2831 |
| F number | 4.51841 | 5.39313 | 6.53084 |
| Angle of view | 46.9719 | 35.3839 | 26.0549 |
| Image height | 20.0000 | 21.0000 | 21.6330 |
| Total optical length | 87.3161 | 83.8167 | 84.2164 |
| d8 | 22.6993 | 11.6053 | 3.0000 |
| d15 | 1.8337 | 2.1380 | 3.2000 |
| d17 | 28.8797 | 36.1700 | 44.1130 |
| Entrance pupil position | 17.2260 | 14.6026 | 11.6746 |
| Exit pupil position | −40.3090 | −47.7706 | −56.2935 |
| Anterior principal point | 27.2919 | 25.7154 | 21.6555 |
| Posterior principal point | 66.4219 | 53.6754 | 40.8952 |

TABLE 2D
(Data about single lenses)

| Lens | Start surface | Focal length |
|---|---|---|
| 1 | 1 | −30.7715 |
| 2 | 3 | 1842.5264 |
| 3 | 5 | −35.9043 |
| 4 | 7 | 40.9805 |
| 5 | 10 | 15.3827 |
| 6 | 12 | −10.1293 |
| 7 | 14 | 11.6857 |
| 8 | 16 | −32.7787 |

TABLE 2E
(Data about zoom lens groups)

| | | | Lens | Anterior | Posterior |
|---|---|---|---|---|---|
| | Start | | configuration | principal | principal |
| Group | surface | Focal length | length | point | point |
| 1 | 1 | −28.58421 | 17.90340 | 1.29204 | 4.59848 |
| 2 | 9 | 17.97139 | 11.10000 | 2.11654 | 4.76569 |
| 3 | 16 | −32.77867 | 1.80000 | 0.18111 | 0.84937 |

TABLE 2F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 9 | −0.36877 | −0.47746 | −0.61897 |
| 3 | 16 | 1.98309 | 2.20286 | 2.44637 |

### (Third Example of Numerical Values)

Following is a third exemplary set of numerical values for the imaging optical system corresponding to the third embodiment shown in FIG. 3A. Specifically, as the third example of numerical values for the imaging optical system, surface data is shown in Table 3A, aspheric surface data is shown in Table 3B, and various types of data in the infinity in-focus state are shown in Tables 3C-3F.

TABLE 3A
(Surface data)

| Surface No. | r | d | nd | vd |
|---|---|---|---|---|
| Object surface | ∞ | | | |
| 1 | 30.00000 | 1.20000 | 2.05090 | 26.9 |
| 2 | 14.53720 | 4.64780 | | |
| 3* | 82.00780 | 2.80000 | 1.53380 | 55.6 |
| 4* | 32.36190 | 5.10450 | | |
| 5 | −53.84480 | 0.90000 | 1.59283 | 68.6 |
| 6 | 39.91180 | 0.53270 | | |
| 7 | 26.47820 | 4.20000 | 1.80809 | 22.8 |
| 8 | 632.98110 | Variable | | |
| 9 (Aperture) | ∞ | 1.50000 | | |
| 10* | 13.21070 | 3.10940 | 1.80998 | 40.9 |
| 11* | −300.00000 | 2.44910 | | |
| 12 | −940.69830 | 0.50000 | 1.80610 | 33.3 |
| 13 | 7.36220 | 0.01000 | 1.56732 | 42.8 |
| 14 | 7.36220 | 3.53150 | 1.49700 | 81.6 |
| 15 | −15.99550 | Variable | | |
| 16* | −33.26220 | 1.10000 | 1.53380 | 55.6 |
| 17* | 120.00000 | Variable | | |
| 18 | ∞ | 2.10000 | 1.51680 | 64.2 |
| 19 | ∞ | 1.00000 | | |
| Image plane | ∞ | | | |

TABLE 3B
(Aspheric surface data)

3^{rd} surface
K = 9.44891E−01, A4 = 1.10925E−04, A6 = −2.09561E−07, A8 = 1.38825E−10
A10 = 8.72661E−12, A12 = −2.21577E−14, A14 = −3.60858E−17
4^{th} surface
K = 8.98781E−01, A4 = 1.16756E−04, A6 = 7.36789E−08, A8 = −5.70612E−09
A10 = 7.93221E−11, A12 = −3.52468E−13, A14 = 1.72808E−16
10^{th} surface
K = 0.00000E+00, A4 = −7.39091E−05, A6 = 2.30028E−07, A8 = −1.80242E−07
A10 = 6.01341E−09, A12 = −1.10169E−10, A14 = 0.00000E+00
11^{th} surface
K = 0.00000E+00, A4 = −5.54399E−05, A6 = −3.58977E−07, A8 = −1.65689E−07
A10 = 5.42608E−09, A12 = −1.00718E−10, A14 = 0.00000E+00
16^{th} surface
K = 0.00000E+00, A4 = 2.29263E−04, A6 = −5.60094E−06, A8 = 1.47830E−07
A10 = −8.19708E−10, A12 = −1.60641E−11, A14 = 0.00000E+00
17^{th} surface
K = 0.00000E+00, A4 = 3.10661E−04, A6 = −1.06217E−05, A8 = 5.80641E−07
A10 = −2.43922E−08, A12 = 6.04793E−10, A14 = −6.44696E−12
(Various types of data in infinity in-focus state)

TABLE 3C
(Various types of data)
(Zoom ratio: 1.69617)

| | Wide-angle | Middle | Telephoto |
|---|---|---|---|
| Focal length | 17.7305 | 23.0874 | 30.0739 |
| F number | 4.51792 | 5.11820 | 5.88089 |
| Angle of view | 51.6270 | 43.6457 | 36.0494 |
| Image height | 20.0000 | 21.0000 | 21.6330 |
| Total optical length | 83.7824 | 81.2177 | 81.4574 |
| d8 | 19.6505 | 11.9326 | 5.8252 |
| d15 | 1.7864 | 1.9521 | 2.3794 |
| d17 | 27.6605 | 32.6480 | 38.5678 |
| Entrance pupil position | 15.4681 | 13.9642 | 12.4068 |
| Exit pupil position | −39.7422 | −44.8387 | −51.0369 |
| Anterior principal point | 25.2871 | 25.1555 | 24.7477 |
| Posterior principal point | 66.0453 | 58.0986 | 51.3498 |

TABLE 3D
(Data about single lenses)

| Lens | Start surface | Focal length |
|---|---|---|
| 1 | 1 | −27.9496 |
| 2 | 3 | −102.1492 |
| 3 | 5 | −38.5272 |
| 4 | 7 | 34.0915 |
| 5 | 10 | 15.6917 |
| 6 | 12 | −9.0601 |
| 7 | 14 | 10.6804 |
| 8 | 16 | −48.6669 |

TABLE 3E
(Data about zoom lens groups)

| | | | Lens | Anterior | Posterior |
|---|---|---|---|---|---|
| | Start | | configuration | principal | principal |
| Group | surface | Focal length | length | point | point |
| 1 | 1 | −24.12219 | 19.38500 | 1.26901 | 4.51850 |
| 2 | 9 | 18.93457 | 11.10000 | 2.25218 | 4.34883 |
| 3 | 16 | −48.66687 | 1.10000 | 0.15526 | 0.53987 |

TABLE 3F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 9 | −0.45129 | −0.55301 | −0.67307 |
| 3 | 16 | 1.62873 | 1.73070 | 1.85230 |

### (Fourth Example of Numerical Values)

Following is a fourth exemplary set of numerical values for the imaging optical system corresponding to the fourth embodiment shown in FIG. 4A. Specifically, as the fourth example of numerical values for the imaging optical system, surface data is shown in Table 4A, aspheric surface data is shown in Table 4B, and various types of data in the infinity in-focus state are shown in Tables 4C-4F.

TABLE 4A
(Surface data)

| Surface No. | r | d | nd | vd |
|---|---|---|---|---|
| Object surface | ∞ | | | |
| 1 | 111.24910 | 2.49900 | 1.62299 | 58.1 |
| 2 | 344.85050 | 0.20000 | | |
| 3 | 39.04740 | 1.10000 | 2.00100 | 29.1 |
| 4 | 13.60580 | 8.08670 | | |
| 5 | −85.84330 | 1.10000 | 1.59283 | 68.6 |
| 6 | 20.97500 | 0.20790 | | |
| 7 | 19.43880 | 5.80610 | 1.75211 | 25.0 |
| 8 | 296.49490 | Variable | | |
| 9 (Aperture) | ∞ | 1.40000 | | |
| 10* | 13.08320 | 3.70000 | 1.80998 | 40.9 |
| 11* | −1000.00000 | 1.03400 | | |
| 12 | 45.19980 | 0.60000 | 1.80610 | 33.3 |
| 13 | 7.36490 | 0.01000 | 1.56732 | 42.8 |
| 14 | 7.36490 | 3.56190 | 1.49700 | 81.6 |
| 15 | −26.41290 | Variable | | |
| 16* | −19.77570 | 1.53070 | 1.53380 | 55.6 |
| 17* | 900.00000 | Variable | | |
| 18 | ∞ | 2.10000 | 1.51680 | 64.2 |
| 19 | ∞ | 1.00000 | | |
| Image plane | ∞ | | | |

TABLE 4B
(Aspheric surface data)

10^{th} surface
K = 0.00000E+00, A4 = −6.05193E−05, A6 = 1.89592E−06, A8 = −2.34889E−07
A10 = 8.33876E−09, A12 = −1.25507E−10, A14 = 0.00000E+00
11^{th} surface
K = 0.00000E+00, A4 = −3.07142E−05, A6 = 2.32034E−06, A8 = −3.32646E−07
A10 = 1.29001E−08, A12 = −2.04486E−10, A14 = 0.00000E+00
16^{th} surface
K = 0.00000E+00, A4 = 7.16225E−04, A6 = −1.54379E−05, A8 = 3.61808E−07
A10 = −8.98837E−09, A12 = 1.17515E−10, A14 = 1.29606E−14
17^{th} surface
K = 0.00000E+00, A4 = 7.16071E−04, A6 = −9.10540E−06, A8 = −9.24790E−08
A10 = 7.83931E−09, A12 = −1.27323E−10, A14 = −3.37398E−14
(Various types of data in infinity in-focus state)

TABLE 4C
(Various types of data)
(Zoom ratio: 2.04650)

| | Wide-angle | Middle | Telephoto |
|---|---|---|---|
| Focal length | 18.8124 | 26.9065 | 38.4995 |
| F number | 4.60834 | 5.51242 | 6.59329 |
| Angle of view | 50.2618 | 39.1674 | 28.9957 |
| Image height | 20.0000 | 21.0000 | 21.6330 |
| Total optical length | 87.3125 | 85.2965 | 84.9847 |
| d8 | 22.5135 | 12.7150 | 4.5000 |
| d15 | 1.8239 | 1.9853 | 3.5708 |
| d17 | 29.0388 | 36.6599 | 42.9776 |
| Entrance pupil position | 16.9939 | 14.9688 | 12.5313 |
| Exit pupil position | −39.9879 | −47.7095 | −54.9784 |
| Anterior principal point | 26.9727 | 26.6902 | 24.0887 |
| Posterior principal point | 68.5760 | 58.3561 | 46.5215 |

TABLE 4D
(Data about single lenses)

| Lens | Start surface | Focal length |
|---|---|---|
| 1 | 1 | 262.5355 |
| 2 | 3 | −21.3222 |
| 3 | 5 | −28.3253 |
| 4 | 7 | 27.4125 |
| 5 | 10 | 15.9700 |
| 6 | 12 | −10.9928 |
| 7 | 14 | 12.0081 |
| 8 | 16 | −36.2294 |

TABLE 4E
(Data about zoom lens groups)

| | | | Lens | Anterior | Posterior |
|---|---|---|---|---|---|
| | Start | | configuration | principal | principal |
| Group | surface | Focal length | length | point | point |
| 1 | 1 | −24.66096 | 18.99970 | 2.57731 | 6.80868 |
| 2 | 9 | 17.56620 | 10.30590 | 1.86920 | 4.64365 |
| 3 | 16 | −36.22936 | 1.53070 | 0.02144 | 0.55474 |

TABLE 4F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 9 | −0.40226 | −0.51864 | −0.68471 |
| 3 | 16 | 1.89638 | 2.10371 | 2.28002 |

### (Fifth Example of Numerical Values)

Following is a fifth exemplary set of numerical values for the imaging optical system corresponding to the fifth embodiment shown in FIG. 5A. Specifically, as the fifth example of numerical values for the imaging optical system, surface data is shown in Table 5A, aspheric surface data is shown in Table 51B, and various types of data in the infinity in-focus state are shown in Tables 5C-5F.

TABLE 5A
(Surface data)

| Surface No. | r | d | nd | vd |
|---|---|---|---|---|
| Object surface | ∞ | | | |
| 1 | 145.51400 | 1.20000 | 1.90366 | 31.3 |
| 2 | 21.04080 | 0.99100 | | |
| 3* | 56.75240 | 2.80000 | 1.53380 | 55.6 |
| 4* | 44.06560 | 5.24990 | | |
| 5 | −113.36270 | 0.90000 | 1.59283 | 68.6 |
| 6 | 72.81750 | 0.37410 | | |
| 7 | 29.72110 | 4.20000 | 1.80518 | 25.5 |
| 8 | 234.01010 | Variable | | |
| 9 (Aperture) | ∞ | 1.50000 | | |
| 10* | 12.81670 | 3.69990 | 1.80998 | 40.9 |
| 11* | −300.00000 | 2.22200 | | |
| 12 | 40.60520 | 0.50000 | 1.80610 | 33.3 |
| 13 | 6.22290 | 0.01000 | 1.56732 | 42.8 |
| 14 | 6.22290 | 4.17640 | 1.49700 | 81.6 |
| 15 | −55.72170 | 1.05330 | | |
| 16* | 94.71780 | 1.00000 | 1.58313 | 59.5 |
| 17* | 13.29960 | Variable | | |
| 18* | 41.32870 | 3.90310 | 1.53380 | 55.6 |
| 19 | 344.47730 | Variable | | |
| 20 | ∞ | 2.10000 | 1.51680 | 64.2 |
| 21 | ∞ | 1.00000 | | |
| Image plane | ∞ | | | |

TABLE 5B
(Aspheric surface data)

3^{rd} surface
K = −3.03205E−01, A4 = 9.12291E−05, A6 = −1.70317E−07, A8 = 4.80458E−10
A10 = 2.48935E−12, A12 = −2.56896E−14, A14 = 5.56985E−17
4^{th} surface
K = 2.74714E−01, A4 = 9.56179E−05, A6 = −1.56448E−07, A8 = 2.16577E−10
A10 = 9.00574E−12, A12 = −7.74235E−14, A14 = 1.84046E−16
10^{th} surface
K = 0.00000E+00, A4 = −4.53962E−06, A6 = −8.04827E−07, A8 = 3.43337E−08
A10 = −7.38922E−10, A12 = 6.20957E−12, A14 = 0.00000E+00
11^{th} surface
K = 0.00000E+00, A4 = 4.95748E−05, A6 = −8.50097E−07, A8 = 3.80261E−08
A10 = −8.91011E−10, A12 = 8.42035E−12, A14 = 0.00000E+00
16^{th} surface
K = 0.00000E+00, A4 = −1.48070E−04, A6 = 1.25291E−05, A8 = −5.58940E−07
A10 = 1.81660E−08, A12 = −1.82258E−10, A14 = 0.00000E+00
17^{th} surface
K = 0.00000E+00, A4 = −2.36783E−04, A6 = 6.93683E−06, A8 = −1.76554E−07
A10 = −8.48798E−10, A12 = 1.90643E−10, A14 = −2.93084E−12
18^{th} surface
K = 0.00000E+00, A4 = −7.41983E−06, A6 = 2.96220E−08, A8 = −6.23047E−11
A10 = 1.65405E−13, A12 = −2.12472E−16, A14 = 0.00000E+00
(Various types of data in infinity in-focus state)

TABLE 5C
(Various types of data)
(Zoom ratio: 1.92306)

| | Wide-angle | Middle | Telephoto |
|---|---|---|---|
| Focal length | 24.9597 | 34.6116 | 47.9991 |
| F number | 4.67546 | 5.30328 | 6.30592 |
| Angle of view | 41.9670 | 32.0865 | 24.4016 |
| Image height | 20.0000 | 21.0000 | 21.6330 |
| Total optical length | 95.3496 | 87.0631 | 87.5201 |
| d8 | 27.4297 | 12.5662 | 3.0000 |
| d17 | 17.0402 | 12.6982 | 11.6711 |
| d19 | 14.0000 | 24.9190 | 35.9693 |
| Entrance pupil position | 18.1978 | 14.0683 | 10.2619 |
| Exit pupil position | −52.4765 | −55.6647 | −65.0288 |
| Anterior principal point | 31.2875 | 27.1393 | 22.8040 |
| Posterior principal point | 70.3977 | 52.4010 | 39.4699 |

TABLE 5D
(Data about single lenses)

| Lens | Start surface | Focal length |
|---|---|---|
| 1 | 1 | −27.3451 |
| 2 | 3 | −400.0003 |
| 3 | 5 | −74.6560 |
| 4 | 7 | 41.8983 |
| 5 | 10 | 15.2559 |
| 6 | 12 | −9.1765 |
| 7 | 14 | 11.5210 |
| 8 | 16 | −26.6534 |
| 9 | 18 | 87.5860 |

TABLE 5E
(Data about zoom lens groups)

| | | | Lens | Anterior | Posterior |
|---|---|---|---|---|---|
| | Start | | configuration | principal | principal |
| Group | surface | Focal length | length | point | point |
| 1 | 1 | −38.55272 | 15.71500 | −1.99425 | 0.74662 |
| 2 | 9 | 31.35226 | 14.16160 | −11.82696 | −1.81248 |
| 3 | 16 | 87.58602 | 3.90310 | −0.34538 | 1.02435 |

TABLE 5F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 9 | −0.83005 | −1.36861 | −2.34991 |
| 3 | 18 | 0.77998 | 0.65597 | 0.52982 |

### (Values Corresponding to Inequalities)

Values, corresponding to the inequalities (1) to (14), of the respective examples of numerical values are shown in the following Table 6:

| | | 1^{st} example of | 2^{nd} example of | 3^{rd} example of | 4^{th} example of | 5^{th} example of |
|---|---|---|---|---|---|---|
| | | numerical | numerical | numerical | numerical | numerical |
| Condition | Inequality | values | values | values | values | values |
| (1) | L1nd | 2.00100 | 1.90366 | 2.05090 | 2.00100 | 1.90366 |
| (2) | R11/fw | 1.580 | 1.782 | 1.692 | 2.076 | 5.830 |
| (3) | L1νd | 68.6 | 68.6 | 68.6 | 68.6 | 68.6 |
| | | (L3) | (L3) | (L3) | (L2) | (L3) |
| (4) | G1L/Lt | 0.231 | 0.213 | 0.238 | 0.224 | 0.180 |
| (5) | \| f1/fw \| | 1.353 | 1.367 | 1.360 | 1.311 | 1.545 |
| (6) | L2νd | 81.6 | 81.6 | 81.6 | 81.6 | 81.6 |
| | | (L7) | (L7) | (L7) | (L7) | (L7) |
| (7) | G2L/Lt | 0.124 | 0.132 | 0.136 | 0.121 | 0.162 |
| (8) | G2m/Lt | 0.196 | 0.197 | 0.141 | 0.185 | 0.190 |
| (9) | L3nd | 1.53380 | 1.58313 | 1.53380 | 1.53380 | 1.53380 |
| (10) | L3νd | 55.6 | 59.5 | 55.6 | 55.6 | 55.6 |
| (11) | \| f3/fw \| | 1.029 | 0.757 | 1.618 | 0.941 | 1.825 |
| (12) | LTt/Lt | 0.447 | 0.439 | 0.488 | 0.458 | 0.554 |
| (13) | BFw/Yw | 1.566 | 1.599 | 1.538 | 1.607 | 0.855 |
| (14) | Lt/Lw | 0.984 | 0.965 | 0.972 | 0.973 | 0.918 |

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The imaging optical system according to the present disclosure is applicable to various types of cameras including digital still cameras, lens interchangeable digital cameras, digital camcorders, cameras for cellphones and smartphones, and cameras for personal digital assistants (PDAs), surveillance cameras for surveillance systems, Web cameras, and onboard cameras. Among other things, the present disclosure is particularly suitably applicable to imaging optical systems that are required to provide high image quality such as digital still camera systems and digital camcorder systems.

1. An imaging optical system consisting of:
a first lens group having negative power;
a second lens group having positive power; and
a third lens group having power, the first lens group, the second lens group, and the third lens group being arranged in this order such that the first lens group is located closer to an object than the second lens group or the third lens group is, and that the third lens group is located closer to an image plane than the first lens group or the second lens group is,
the first lens group, the second lens group, and the third lens group moving along an optical axis of the imaging optical system such that an interval between two adjacent ones of the first, second, and third lens groups changes while the imaging optical system is zooming from a wide-angle end toward a telephoto end, and
the imaging optical system satisfying the following inequality (1):
$$1.85 < L 1 nd \qquad ( 1 )$$
where L1nd is a refractive index of a negative lens located closest to the object

2. The imaging optical system of claim 1, wherein
the third lens group has negative power.

3. The imaging optical system of claim 1, wherein
the first lens group consists of three or more lenses.

4. The imaging optical system of claim 1, wherein
the imaging optical system satisfies the following inequality (2):
$$0.5 < R 11 / fw < 0.8 \qquad ( 2 )$$
where R11 is a radius of curvature of an object-side surface of the negative lens located closest to the object and
fw is a focal length of the imaging optical system at the wide-angle end.

5. The imaging optical system of claim 1, wherein
the first lens group includes two or more negative lenses, and
the imaging optical system satisfies the following inequality (3):
$$60 < L 1 ν d < 100$$
where L1νd is an abbe number of one of the two or more negative lenses.

6. The imaging optical system of claim 1, wherein
the imaging optical system satisfies the following inequality (4):
$$0.1 < G 1 L / Lt < 0.4 \qquad ( 4 )$$
where G1L is a total thickness of the first lens group, and
Lt is a total optical length of the imaging optical system at the telephoto end.

7. The imaging optical system of claim 1, wherein
the first lens group is configured to move to draw a locus that is convex toward the image plane while the imaging optical system is zooming from the wide-angle end toward the telephoto end.

8. The imaging optical system of claim 1, wherein
the imaging optical system satisfies the following inequality (5):
$$0.5 < \vert f 1 / fw \vert < 3. \qquad ( 5 )$$
where f1 is a focal length of the first lens group, and
fw is a focal length of the imaging optical system at the wide-angle end.

9. The imaging optical system of claim 1, wherein
the second lens group includes one or more positive lenses, and
the imaging optical system satisfies the following inequality (6):
$$65 < L 2 ν d < 100 \qquad ( 6 )$$
where L2νd is an abbe number of at least one positive lens belonging to the one or more positive lenses.

10. The imaging optical system of claim 1, wherein
the second lens group includes an aperture stop located closer to the object than any other member of the second lens group is, and
the imaging optical system satisfies the following inequality (7):
$$0.05 < G 2 L / Lt < 0.25 \qquad ( 7 )$$
where G2L is a total thickness of the second lens group, and
Lt is a total optical length of the imaging optical system at the telephoto end.

11. The imaging optical system of claim 1, wherein
the second lens group includes:
a lens having positive power;
a lens having negative power; and
another lens having positive power,
these three lenses being arranged in this order such that one of the lenses, each having positive power, of the second lens group is located closer to the object than remaining two lenses of the second lens group are.

12. The imaging optical system of claim 1, wherein
the second lens group includes an aperture stop arranged to be located closer to the object than any other member of the second lens group is and configured to move along with the other members of the second lens group.

13. The imaging optical system of claim 1, wherein
the imaging optical system satisfies the following inequality (8):
$$0.05 < G 2 m / Lt < 0.4 \qquad ( 8 )$$
where G2m is a magnitude of movement of the second lens group while the imaging optical system is zooming from the wide-angle end toward the telephoto end, and
Lt is a total optical length of the imaging optical system at the telephoto end.

14. The imaging optical system of claim 1, wherein
the third lens group consists of a single lens, and
the imaging optical system satisfied the following inequalities (9) and (10):
$$L 3 nd < 1 \text{.65} \qquad ( 9 )$$
$$L 3 ν d < 65 \qquad ( 10 )$$
where L3nd is a refractive index of the single lens that forms the third lens group, and
L3νd is an abbe number of the single lens that forms the third lens group.

15. The imaging optical system of claim 1, wherein
the imaging optical system satisfied the fooling inequality (11):
$$0.3 < \vert f 3 / fw \vert < 2.5 \qquad ( 11 )$$
where f3 is a focal length of the third lens group, and
fw is a focal length of the imaging optical system at the wide-angle end.

16. The imaging optical system of claim 1, wherein
the imaging optical system satisfies the following inequality (12):
$$0.2 < LTt / Lt < 0.8 \qquad ( 12 )$$
where LTt is a total lens length of the imaging optical system at the telephoto end, and
Lt is a total optical length of the imaging optical system at the telephoto end.

17. The imaging optical system of claim 1, wherein
the imaging optical system satisfies the following inequality (13):
$$0.5 < BFw / Yw < 2.5 \qquad ( 13 )$$
where BFw is a back focus of the imaging optical system at the wide-angle end, and
Yw is an image height of the imaging optical system at the wide-angle end.

18. The imaging optical system of claim 1, wherein
the imaging optical system satisfied the following inequality (14):
$$0.6 < Lt / Lw < 1.2 \qquad ( 14 )$$
where Lt is a total optical length of the imaging optical system at the telephoto end, and
Lw is a total optical length of the imaging optical system at the wide-angle end.

19. A camera system comprising:
an interchangeable lens unit including the imaging optical system of claim 1; and
a camera body including: an image sensor configured to receive an optical image of an object formed by the imaging optical system and transform the optical image into an electrical image signal; and a camera mount, the camera body being configured to be connected removably to the interchangeable lens unit via the camera mount,
the interchangeable lens unit being configured to form the optical image of the object on the image sensor.

20. An image capture device configured to transform an optical image of an object into an electrical image signal and display and/or store the electrical image signal thus transformed, the image capture device comprising:
the imaging optical system of claim 1 configured to form the optical image of the object; and
an image sensor configured to transform the optical image formed by the imaging optical system into the electrical image signal.
